(19) United States
(12) Patent Application Publication
(10) Pub. No.: US 2011/0014977 A1
(43) Pub. Date: Jan. 20, 2011

(54) GAME DEVICE, GAME PROCESSING METHOD, INFORMATION RECORDING MEDIUM, AND PROGRAM

(76) Inventor: Yukihiro Yamazaki, Tokyo (JP)

Correspondence Address: HOWARD & HOWARD ATTORNEYS PLLC, 450 West Fourth Street, Royal Oak, MI, 48067, US

(21) Appl. No.: 12/934,600

(22) PCT Filed: Mar. 19, 2009
(86) PCT No.: PCT/JP2009/055468

§ 371 Date: Sep. 24, 2010

(30) Foreign Application Priority Data
Mar. 26, 2008 (JP) 2008-081003

(51) Int. Cl. A63F 13/00; A63F 9/24

(52) U.S. Cl. 463/30; 463/43

(57) ABSTRACT

A storage unit stores a position of an object, a viewpoint position, a sight line direction, a position of an indication sign in a screen and a position of an attention area in the screen. An input receiving position receives an instruction input to change the viewpoint. A generation unit generates an image of the virtual space viewed from the viewpoint in the sight line direction. A display unit displays the generated image. A distance calculation unit calculates a distance between an object displayed in the attention area and the viewpoint. A move calculation unit calculates a moving direction and a moving distance of the viewpoint. A correction unit corrects the moving distance so that the corrected moving distance monotonically decreases relative to the calculated distance. An update unit moves the viewpoint in the calculated direction by the corrected moving distance.

### CROSS-REFERENCE TO RELATED APPLICATIONS

The subject patent application is the national stage of the PCT application number PCT/JP2009/055468 which claims priority to, and all the benefits of, Japanese Patent Application No. 2008-081003 filed on Mar. 26, 2008 both of which are hereby incorporated by reference.

### TECHNICAL FIELD

The Present Invention relates to a game device, a game processing method, an information recording medium and a program that are suitable for reducing a burden of scrolling an image display as well as improving visibility of a screen for a player.

### BACKGROUND ART

As a method for displaying, e.g. a game image representing a virtual space, commonly used is a scroll processing in which part of a large virtual space is set to a display area for a monitor display and the display area moves by operation of a player. For example, Patent Literature 1 discloses a device that is used such that a player touches a touch panel with a stick and scrolls a screen in an arbitrary direction. This enables the player not only to scroll the screen in a predetermined direction such as up, down, left or right but also to scroll the screen in various directions according to the player's need.

Patent Literature 1: Unexamined Japanese Patent Application KOKAI Publication No. 2006-146556

Meanwhile, there exists a game that is played by changing a viewpoint position and a sight line direction in a virtual space according to a change of a position and a posture of a controller gripped and operated by a player and displaying an image of the virtual space viewed from this viewpoint in this sight line direction on a screen. In such a game, if a change amount of a direction or the posture of the controller is over a predetermined amount, the aforementioned scroll processing needs to be performed.

### DISCLOSURE OF INVENTION

However, if the direction and amount of scroll is left to the player's decision too much, the player may frequently scroll the screen depending on his/her scroll manner, causing a problem of laying much burden of the scroll processing on the device.

In addition, in a game in which the aforementioned controller is used to change a viewpoint position and a sight line direction placed in a virtual space, thereby moving an object, if the game screen is widely scrolled in the state where players in the game screen may have different levels of attentions, the eyes of the player cannot follow the change of the screen, as a result, the image may become difficult to be seen for the player.

The present invention has been made to solve this problem and an object of the present invention is to provide a game device, a game processing method, an information recording medium and a program that are suitable for reducing the burden of scroll processing of an image display as well as improving visibility of a screen for a player.

A game device according to a first aspect of the present invention includes a storage unit, a generation unit, a display unit, a distance calculation unit and a move calculation unit, a correction unit and an update unit.

The storage unit stores a position of an object placed in a virtual space and a viewpoint position placed in the virtual space.

The generation unit generates an image of the object viewed from the viewpoint position in the virtual space.

The display unit displays the generated image.

The distance calculation unit obtains a distance between the position of the object in the virtual space and the stored viewpoint position.

The move calculation unit calculates a moving direction and a moving distance of the viewpoint position.

The correction unit corrects the calculated moving distance base on the obtained distance.

The update unit performs updating so as to move the stored viewpoint in the calculated moving direction by the corrected moving distance.

The correction unit performs the correction so that the corrected moving distance monotonically decreases relative to the obtained distance.

A game performed by the game device of the present invention is a game in a three-dimensional or two-dimensional virtual space, for example. A monitor displays an image of the virtual space viewed from the viewpoint position in a predetermined sight line direction. One or more object(s) is/are placed in the virtual space. A player can operate a controller to instruct the viewpoint position to change in the specified direction by the specified amount. Moving the viewpoint position moves the image displayed on the screen. To put it simply, the screen scrolls.

When the viewpoint position is changed, the game device obtains a moving direction and a moving distance of the viewpoint per unit time, that is, a scroll direction and a scroll amount of the screen per unit time. The moving direction of the viewpoint is specified by, e.g. the player's moving the controller or pressing an operation button. The moving distance of the viewpoint is obtained as, e.g. a predetermined amount per one operation or an amount changing depending on how to operate. However, the moving distance of the viewpoint obtained in this way is corrected as will be described below.

The game device calculates a distance between the object placed within the screen and viewpoint. The game device corrects the moving distance of the viewpoint so that the corrected moving distance monotonically decreases relative to the calculated distance between the object and the viewpoint. That is, the closer to the viewpoint the object placed within the screen becomes, the smaller the corrected moving distance of the viewpoint becomes. In other words, the closer to the viewpoint the object placed within the screen becomes, the less scroll becomes.

The game device may obtain total moving direction and moving distance of the viewpoint instead of the moving direction and moving distance of the viewpoint per unit time. In this case, the closer to the viewpoint the object placed within the screen becomes, the slower scroll becomes.

If an object is placed within the screen, it is presumed that the player is gazing at the object with more attention. In the state where the player is gazing at a certain area within the screen, if the screen scrolls quickly, the screen may become difficult to be seen. However, the present invention prevents an image from being difficult to be seen on the whole due to too much amount of scroll and too fast scroll, thereby improving visibility of the screen for the player. For example, the present invention prevents the frequent scroll of the screen, thereby preventing the player from becoming dizzy. Furthermore, the present invention prevents the frequent occurrences of scroll processing of the screen due to the move of the viewpoint, thereby reducing the burden of scroll processing on the game device.

A game device according to another aspect of the present invention includes a storage unit, a generation unit, a display unit, a distance calculation unit, a move calculation unit, a correction unit and an update unit.

The storage unit stores a position of an object placed in a virtual space, a viewpoint position placed in the virtual space, and a sight line direction placed in the virtual space.

The generation unit generates an image of the object viewed from the viewpoint position in the sight line direction in the virtual space.

The display unit displays the generated image.

The distance calculation unit obtains a distance between the position of the object in the virtual space and the stored viewpoint position.

The move calculation unit calculates a rotation direction and a rotation angle of the rotation of the sight line direction.

The correction unit corrects the calculated rotation angle based on the obtained distance.

The update unit performs updating so as to rotate the stored sight line direction in the calculated rotation direction by the corrected rotation angle.

The correction unit performs the correction so that the corrected rotation angle monotonically decreases relative to the obtained distance.

A game performed by the game device of the present invention is a game in, e.g. a three-dimensional space. A monitor displays an image of the virtual space viewed from the viewpoint position in the sight line direction. One or more object(s) is/are placed in the virtual space. A player can operate a controller to instruct the sight line direction to move in the specified direction by the specified amount. Moving the sight line direction moves the image displayed on the screen. To put it simply, the screen scrolls.

When the sight line direction is changed, the game device obtains a rotation direction and a rotation angle of the sight line per unit time, that is, a scroll direction and a scroll amount of the screen per unit time. The rotation direction of the sight line is specified by, e.g. the player's moving the controller or pressing an operation button. The rotation angle of the sight line is obtained as, e.g. a predetermined amount per one operation or an amount changing depending on how to operate. However, the rotation direction of the sight line obtained in this way is corrected as will be described below.

The game device calculates a distance between the object placed within the screen and viewpoint. The game device corrects the rotation angle of the sight line so that the corrected rotation angle monotonically decreases relative to the calculated distance between the object and viewpoint. That is, the closer to the viewpoint the object placed within the screen becomes, the smaller the corrected rotation angle of the sight line becomes. In other words, the closer to the viewpoint the object placed within the screen becomes, the less scroll becomes.

The game device may obtain a total rotation direction and a total rotation angle of the sight line instead of the rotation direction and the rotation angle of the sight line per unit time. In this case, the closer to the viewpoint the object placed within the screen becomes, the slower scroll becomes.

In the state where the player is gazing at a certain area within the screen with more attention, if the screen scrolls quickly, the screen may become difficult to be seen. However, the present invention prevents an image on the whole from becoming difficult to be seen due to too much amount of scroll and too fast scroll, thereby improving visibility of the screen for the player. For example, the present invention prevents the frequent scroll of the screen, thereby preventing the player from becoming dizzy. Furthermore, the present invention prevents the frequent occurrences of scroll processing of the screen due to the move of the viewpoint, thereby reducing the burden of scroll processing on the game device.

The move calculation unit may further calculate a moving direction and a moving distance of the viewpoint position.

The correction unit may further correct the calculated moving distance based on the obtained distance.

The update unit may further perform updating so as to move the stored viewpoint position in the calculated moving direction by the corrected moving distance.

The correction unit may perform the correction so that the corrected moving distance monotonically decreases relative to the obtained distance.

In the game device according to the present invention, the player can change not only the sight line direction but also the viewpoint position. That is, the player can scroll the screen so as to change the sight line direction or to change the viewpoint position. In scrolling the screen, the game device obtains not only the rotation direction and rotation angle of the sight line but also the moving direction and moving distance of the viewpoint. The moving direction of the viewpoint is specified by, e.g. the player's moving the controller or pressing an operation button. The moving distance of the viewpoint is obtained as, e.g. a predetermined amount per one operation or an amount changing depending on how to operate. However, the moving distance of the viewpoint obtained in this way will be corrected, similarly to the rotation direction of sight line.

The game device corrects the moving distance of the viewpoint so that, similarly to the rotation direction of the sight line, the corrected moving distance monotonically decreases relative to the calculated distance between the object and the viewpoint. That is, the closer to the viewpoint the object placed within the screen becomes, the smaller the corrected moving distance of the viewpoint becomes. In other words, the closer to the viewpoint the object placed within the screen becomes, the less (slower) scroll becomes.

Therefore, the present invention prevents an image on the a whole from becoming difficult to be seen due to too much amount of scroll and too fast scroll, thereby improving visibility of the screen for the player. For example, the present invention prevents the frequent scroll of the screen, thereby preventing the player from becoming dizzy. Furthermore, the present invention prevents the frequent occurrences of scroll processing of the screen due to the move of the viewpoint, thereby reducing the burden of scroll processing on the game device.

A plurality of objects may be placed in the virtual space.

The storage unit may store the position of each of the plurality of objects.

The distance calculation unit may obtain a distance between the stored viewpoint position and a position of an object drawn within an attention area in a generated image of the objects, among the plurality of the objects, in the virtual space.

An attention area is an area that is presumed to attract more attention than other areas from the player.

The game device corrects a moving distance of the viewpoint so that the corrected moving distance monotonically decreases relative to the calculated distance between the object and viewpoint. That is, the closer to the viewpoint the object placed within the attention area in the screen becomes, the smaller the corrected moving distance of the viewpoint becomes. In other words, the closer to the viewpoint the object placed within the attention area in the screen becomes, the less scroll becomes. The game device may obtain a total moving direction and a total moving distance of the viewpoint instead of the moving direction and moving distance of the viewpoint per unit time. In this case, the closer to the viewpoint the object placed within the attention area of the screen becomes, the slower scroll becomes.

Alternatively, the game device corrects the rotation angle of the sight line so that the corrected rotation angle monotonically decreases relative to the calculated distance between the object and the viewpoint. That is, the closer to the viewpoint the object placed within the attention area of the screen becomes, the smaller the corrected rotation angle of the sight line becomes. In other words, the closer to the viewpoint the object placed within the attention area of the screen becomes, the less scroll becomes.

The game device may obtain a total rotation direction and a total rotation angle of the sight line instead of the rotation direction and rotation angle of the sight line per unit time. In this case, the closer to the viewpoint the object placed within the attention area of the screen becomes, the slower scroll becomes.

The attention area may be placed in the center of the generated image.

For example, it is presumed that the player plays the game while frequently watching around the center of the screen. Therefore, in the present invention, the position of the attention area that is used for correcting a scroll amount is fixed to around the center of the screen. That is, the closer to the viewpoint the object placed around the center of the screen becomes, the less (slower) scroll becomes since it is presumed that the player frequently watches around the center of the screen. Therefore, visibility of the screen can be improved and also the burden of scroll can be reduced.

The game device may further includes an input receiving unit to receive a selection instruction input to select the object from a user.

The distance calculation unit may set the attention area so that the position of the selected object is centered in the generated screen.

For example, in a game in which the player can select any object, it is presumed that the player plays the game while frequently watching around the selected object. For example, in a game in which the player freely operates any of objects placed in the virtual space to move, it is presumed that the player plays the game while watching around the object to be operated.

Therefore, according to the present invention, a position of the attention area that is used for correcting a scroll amount is placed around the object selected by the player. That is, the closer to the viewpoint the selected object or another object placed around the selected object becomes, the less (slower) scroll becomes since it is presumed that the player frequently watches around the selected object. Therefore, visibility of the screen can be improved and also the burden of scroll can be reduced.

The input receiving unit may further receive a move instruction input to move the selected object from the user.

The storage unit may further store a history of a predetermined number of times of the move instruction inputs.

The update unit may further update the position of the selected object on the basis of the move instruction input.

The distance calculation unit, if the position of the selected object moves, may change the position of the attention area so as to follow the object base on the stored history in a predetermined time period after the object has started to move.

For example, there is a game in which the player can freely operate any of objects placed in a virtual space to move. The position of the attention area that is used for correcting a scroll amount is placed around an object selected by the player. A position of the object is variable and the position of the attention area is also variable. That is, in the game device, if the position of the object is changed, accordingly the position of the attention area is changed. If move of the position of the object is too fast, it is expected that the eyes of the player cannot follow the move, but follows with slight delay.

Then, according to the present invention, in a predetermined time period after the position of the object is changed, the position of the attention area is changed. Therefore, the attention area, i.e. the place that is presumed to attract more attention from the player can be moved depending on the player's actual condition, thereby improving visibility of the screen.

The input receiving unit may further receive a move instruction input to move the position of the selected object by a predetermined amount.

The storage unit may further store a history of predetermined number of times of the move instruction inputs.

The correction unit may obtain a correction amount of the moving distance based on a predetermined amount indicated by each of the stored move instruction inputs and correct the moving distance so that the corrected moving distance monotonically decreases relative to the obtained distance.

For example, there is a game in which the player can freely operate any of the objects placed in a virtual space to move. The position of the attention area that is used for correcting a scroll amount is placed around the object selected by the player. The position of the object is variable and the position of the attention area is also variable. That is, in the game device, if the position of the object is changed, accordingly the position of the attention area is changed. In the game device, if the position of the object moves through a moving route, the attention area can move in the same route of that. However, if the position of the object instantly and widely moves or quickly moves due to, e.g. shaking of the player's hand, a place to be gazed by the player may not be in accordance with the moving route.

Then, according to the present invention, the game device properly changes a correction amount of the scroll amount based on a moving history of the position of the object, thereby moving the attention area in a moving route different from that of the object. For example, if the player's unintended movement such as the shaking of her/his hand happens or if the performed movement is presumed to be the player's unintended movement, the game device may cut the amount over the threshold value from the moving amount of the object or may correct the moving amount with the use of a predetermined function for correction. Therefore, since the attention area, i.e. a place that is presumed to attract more attention from the player can be changed according to the moving history of the object, visibility of the screen can be further improved.

If a plurality of objects is drawn within an attention area of the generated image, the distance calculation unit may calculate the average value of distances between positions of respective objects in the virtual space and the stored viewpoint position.

The correction unit may correct the calculated moving distance so as to monotonically decrease relative to the calculated average value.

Not one object but a plurality of objects may be placed within the attention area. The game device can employ any of the objects within the attention area, as an object whose distance from the viewpoint is calculated. Then, according to the present invention, for respective objects within the attention area, distances from the viewpoint are obtained; and a correction amount of the moving distance is obtained so that it monotonically decreases relative to the average value of the distances from the viewpoint.

For example, if respective objects within an area that is presumed to attract more attention are close to the viewpoint on the whole, it can be presumed that the player pays much attention to around the attention area. In this way, since the place that attracts more attention from the player can be presumed according to the actual condition of the player, the visibility of the screen can be further improved.

If a plurality of objects is drawn within an attention area of the generated image, the distance calculation unit may calculate a maximum value of distances between positions of respective objects in the virtual space and the stored viewpoint position.

The correction unit may correct the calculated moving distance so as to monotonically decrease relative to the calculated maximum value.

Not one object but a plurality of objects may be placed within the attention area. The game device can employ any of the objects within the attention area, as an object whose distance from the viewpoint is calculated. Then, according to the present invention, for respective objects within the attention area, the game device obtains distances from the viewpoint and a correction amount of the moving distance so that it monotonically decreases relative to the longest distance among the obtained distances.

For example, if an object that is presumed to highly attract attention is close to the viewpoint within an area that is presumed to attract more attention, it can be presumed that the player pays much attention to around the attention area. In this way, since the area that attracts more attention from the player can be presumed according to the actual condition of the player, the visibility of a screen can be further improved.

If a plurality of objects is drawn within the attention area of the generated image, the distance calculation unit may calculate a minimum value of distances between positions of the respective objects in the virtual space and the stored viewpoint point.

The correction unit may correct the calculated moving distance so as to monotonically decrease relative to the calculated minimum value.

Not one object but a plurality of objects may be placed within the attention area. The game device can employ any of the objects within the attention area, as an object whose distance from the viewpoint is calculated. Then, according to the present invention, for the respective objects within the attention area, the game device obtains distances from the viewpoint and a correction amount of the moving distance so that it monotonically decreases relative to the shortest distance among the obtained distances.

For example, even if an object attracts less attention within the area that is presumed to attract much attention, it can be presumed that the player pays much attention to the object as long as it is close to the viewpoint. Therefore, since the place that attracts more attention from the player can be presumed according to the actual condition of the player, the visibility of a screen can be further improved.

The distance calculation unit may calculate, if a plurality of objects is drawn within an attention area of the generated image, a total value of distances between positions of the respective objects in the virtual space and the stored viewpoint position.

The correction unit may correct the calculated moving distance so as to monotonically decrease relative to the calculated total value.

Not one object but a plurality of objects may be placed within the attention area. The game device can employ any of the objects within the attention area, as an object whose distance from the viewpoint is calculated. Then, according to the present invention, for the respective objects within the attention area, the game device obtains distances from the viewpoint and a correction amount of the moving distance so that it monotonically decreases relative to the total distance.

For example, even if the respective objects within the area that is presumed to attract more attention are far from the viewpoint on the whole, it can be presumed that the player pays much attention to the object as long as the number of these objects is large. Therefore, since the place that attracts more attention from the player can be presumed according to the actual condition of the player, the visibility of a screen can be further improved.

A game processing method according to another aspect of the present invention is a game processing method performed by a game device with a storage unit and includes a generation step, a display step, a distance calculation step, a move calculation step, a correction step and an update step.

The storage unit stores a position of an object placed in a virtual space and a viewpoint placed in the virtual space.

In the generation step, an image representing the object viewed from the viewpoint position in the virtual space is generated.

In the display step, the generated image is displayed.

In the distance calculation step, a distance between the position of the object in the virtual space and the stored viewpoint position is obtained.

In the move calculation step, a moving direction and a moving distance of the move of the viewpoint position are calculated.

In the correction step, the calculated moving distance is corrected based on the obtained distance.

In the update step, updating is performed so as to move the stored viewpoint position in the calculated moving direction by the corrected moving distance.

In the correction step, the corrected moving distance is corrected so as to monotonically decrease relative to the obtained distance.

The present invention prevents an image on the whole from being difficult to be seen due to too much amount of scroll and too fast scroll, thereby improving visibility of the screen for the player. For example, the present invention prevents frequent scroll of the screen, thereby preventing the player from becoming dizzy. Furthermore, the present invention prevents the frequent occurrences of scroll processing of the screen due to the move of the viewpoint, thereby reducing the burden of scroll processing.

A game processing method according to another aspect of the present invention is a game processing method performed by a game device with a storage unit and includes a generation step, a display step, a distance calculation step, a move calculation step, a correction step and an update step.

The storage unit stores a position of an object placed in a virtual space, a position of a viewpoint placed in the virtual space, and a sight line direction placed in the virtual space.

In the generation step, an image representing the object viewed from the viewpoint position in the sight line direction in the virtual space is generated.

In the display step, the generated image is displayed.

In the distance calculation step, a distance between the position of the object in the virtual space and the stored viewpoint position is obtained.

In the move calculation step, a rotation direction and a rotation angle of the rotation of the sight line direction are calculated.

In the correction step, the calculated rotation angle is corrected based on the obtained distance.

In the update step, updating is performed so as to rotate the stored sight line direction in the calculated rotation direction by the corrected rotation angle.

In the correction step, the correction is performed so that the corrected rotation angle monotonically decreases relative to the obtained distance.

The present invention prevents an image on the whole from being difficult to be seen due to too much amount of scroll and too fast scroll, thereby improving visibility of the screen for the player. For example, the present invention prevents the frequent scroll of the screen, thereby preventing the player from becoming dizzy. Furthermore, the present invention prevents the frequent scroll processing of the screen due to the move of the viewpoint, thereby reducing the burden of scroll processing.

An information recording medium according to another aspect of the present invention makes a computer function as:
a storage unit which stores a position of an object placed in a virtual space and a position of a viewpoint placed in the virtual space;
a generation unit which generates an image representing the object viewed from the viewpoint position in the virtual space;
a display unit which displays the generated image;
a distance calculation unit which obtains a distance between the position of the object in the virtual space and the stored viewpoint position;
a move calculation unit which calculates a moving direction and a moving distance of the move of the viewpoint;
a correction unit which corrects the calculated moving distance based on the obtained distance; and
a update unit which performs updating so as to move the stored viewpoint position in the calculated moving direction by the corrected moving distance;
wherein the correction unit performs the correction so that the corrected moving distance monotonically decreases relative to the obtained distance.

The present invention can make a computer function as a game device that operates as described above.

An information recording medium according to another aspect of the present invention makes a computer function as:
a storage unit which stores a position of an object placed in a virtual space, a viewpoint position placed in the virtual space, and a sight line direction placed in the virtual space;
a generation unit which generates an image representing the object viewed from the viewpoint position in the sight line direction in the virtual space;
a display unit which displays the generated image;
a distance calculation unit which obtains a distance between a position of the object in the virtual space and the stored viewpoint position;
a move calculation unit which calculates a rotation direction and a rotation angle of the rotation of the sight line direction;
a correction unit which corrects the calculated rotation angle based on the obtained distance; and
an update unit which performs updating so as to rotate the stored sight line direction in the calculated rotation direction by the corrected rotation angle;
wherein the correction unit performs the correction so that the corrected rotation angle monotonically decreases relative to the obtained distance.

The present invention can make a computer function as a game device that operates as described above.

A program according another aspect of the present invention makes a computer function as:
a storage unit which stores a position of an object placed in a virtual space and a viewpoint position placed in the virtual space;
a generation unit which generates an image representing the object viewed from the viewpoint position in the virtual space;
a display unit which displays the generated image;
a distance calculation unit which obtains a distance between a position of the object in the virtual space and the stored viewpoint position;
a move calculation unit which calculates a moving direction and a moving distance of the move of the viewpoint position;
a correction unit which corrects the calculated moving distance based on the obtained distance; and
an update unit which performs updating so as to move the stored viewpoint position in the calculated moving direction by the corrected moving distance;
wherein the correction unit performs the correction so that the corrected moving distance monotonically decreases relative to the obtained distance.

The present invention can make a computer function as a game device that operates as described above.

A program according to another aspect of the present invention makes a computer function as:
a storage unit which stores a position of an object placed in a virtual space, a viewpoint position placed in the virtual space, and a sight line direction placed in the virtual space;
a generation unit to generate an image representing the object viewed from the viewpoint position in the sight line direction in the virtual space;
a display unit which displays the generated image;
a distance calculation unit which obtains a distance between the position of the object in the virtual space and the stored viewpoint position;
a move calculation unit which calculates a rotation direction and a rotation angle of the rotation of the sight line direction;
a correction unit which corrects the calculated rotation angle based on the obtained distance; and
an update unit which performs updating so as to rotate the stored sight line direction in the calculated rotation direction by the corrected rotated angle;
wherein the correction unit performs the correction so that the corrected rotation angle monotonically decreases relative to the obtained distance.

The present invention can make a computer function as a game device that operates as described above.

A program of the present invention can be recorded in a computer-readable information storage medium such as a compact disc, a flexible disk, a hard disk, a magnetic optical disk, a digital video disk, a magnetic tape and a semiconductor memory.

The aforementioned program can be distributed and sold via a computer communication network separately from a computer on which a program is executed. The aforementioned information storage medium can be distributed and sold separately from a computer.

The present invention can reduce a burden of scroll processing of an image display and improve visibility of the screen for the player.

### BRIEF DESCRIPTION OF DRAWINGS

FIG. 1 is a diagram illustrating a schematic configuration of a typical information processing device in which a game device of the present invention is implemented.

FIG. 2 is outline views of a controller and an information processing device that are used in the present embodiment.

FIG. 3 is a diagram illustrating a correspondence relationship between a virtual space and a real world.

FIG. 4 is a diagram illustrating a position relationship between a handle of a reacher and an object, as well as a direction of force.

FIG. 5 is a diagram illustrating a screen on which a cursor, a reacher and an object are displayed.

FIG. 6 is a diagram illustrating a relationship between a position of a reacher and a moving direction of a viewpoint.

FIG. 7A is a diagram illustrating a processing to move a sight line direction.

FIG. 7B is a diagram illustrating a processing to move a sight line direction.

FIG. 7C is a diagram illustrating a processing to move a sight line direction.

FIG. 8 is a diagram illustrating a functional configuration of a game device of the present invention.

FIG. 9A is an example of an image representing a virtual space displayed on a screen.

FIG. 9B is a diagram illustrating a process of move of a viewpoint position in a virtual space.

FIG. 10A is a diagram illustrating a relationship of a distance between a viewpoint position and a position of an object, to a moving amount of the viewpoint position or a moving amount of a sight line direction.

FIG. 10B is a diagram illustrating a relationship of a distance between a viewpoint position and a position of an object, to a moving amount of the viewpoint position or a moving amount of a sight line direction.

FIG. 10C is a diagram illustrating a relationship of a distance between a viewpoint position and a position of an object, to a moving amount of the viewpoint position or a moving amount of a sight line direction.

FIG. 10D is a diagram illustrating a relationship of a distance between a viewpoint position and a position of an object, to a moving amount of the viewpoint position or a moving amount of a sight line direction.

FIG. 11A is an example of an image representing a virtual space displayed on a screen.

FIG. 11B is a diagram illustrating a process to move a sight line direction in the virtual space.

FIG. 12 is a flow chart illustrating an image display processing.

FIG. 13A is an example of an image representing a virtual space displayed on a screen according to a second embodiment.

FIG. 13B is a diagram illustrating position relationships between a viewpoint, an object and so on in the virtual space.

FIG. 14A is an example of an image representing a virtual space displayed on a screen according to a third embodiment.

FIG. 14B is a diagram illustrating position relationships between a viewpoint, an object and so on in the virtual space.

FIG. 15A is an example of an image representing a virtual space displayed on a screen according to a fourth embodiment.

FIG. 15B is a diagram illustrating position relationships between a viewpoint, an object and so on in the virtual space.

FIG. 16 is a diagram illustrating a trajectory of an object and a trajectory of an attention area.

FIG. 17A is a diagram illustrating a trajectory of an object and a trajectory of an attention area according to the fourth embodiment.

FIG. 17B is a diagram illustrating the trajectory of the object and the trajectory of the attention area according to the fourth embodiment.

FIG. 17C is a diagram illustrating the trajectory of the object and the trajectory of the attention area according to the fourth embodiment.

FIG. 17D is a diagram illustrating the trajectory of the object and the trajectory of the attention area according to the fourth embodiment.

FIG. 18A is a diagram illustrating the trajectory of the object and the trajectory of the attention area according to the fourth embodiment.

FIG. 18B is a diagram illustrating the trajectory of the object and the trajectory of the attention area according to the fourth embodiment.

FIG. 18C is a diagram illustrating the trajectory of the object and the trajectory of the attention area according to the fourth embodiment.

FIG. 18D is a diagram illustrating the trajectory of the object and the trajectory of the attention area according to the fourth embodiment.

FIG. 19A is a diagram illustrating a processing for obtaining the trajectory of the attention area according to the fourth embodiment.

FIG. 19B is a diagram illustrating the processing for obtaining the trajectory of the attention area according to the fourth embodiment.

FIG. 19C is a diagram illustrating the processing for obtaining the trajectory of the attention area according to the fourth embodiment.

FIG. 20A is another example of an image representing a virtual space displayed on a screen according to the fourth embodiment.

FIG. 20B is a diagram illustrating position relationships between a viewpoint, an object and so on in the virtual space.

FIG. 21 is a diagram illustrating a functional configuration of a game device according to a fifth embodiment.

FIG. 22A is an example of an image representing a virtual space displayed on a screen according to the fifth embodiment.

FIG. 22B is a diagram illustrating position relationships between a pseudo viewpoint, characters and so on.

FIG. 23A is an example of a zoomed-out image according to the fifth embodiment.

FIG. 23B is a diagram illustrating position relationships between a pseudo viewpoint, characters and so on.

FIG. 24 is a flow chart illustrating an image display processing.

### EXPLANATION OF REFERENCE NUMBERS

100 information processing device
101 CPU
102 ROM
103 RAM
104 interface
105 controller
106 external memory
107 image processor
108 DVD-ROM drive
109 NIC
110 sound processor
111 microphone
201 grip module
202 CCD camera
203 cross key
204 A-button
205 B-button
206 various buttons
207 indicator
208 power button
251 light-emitting module
252 light-emitting diode
291 television device
301 virtual space
302 reacher
303 object
304 handle
305 viewpoint
306 sight line
307 projection plane
308 cursor
309 obstacle
311 posture direction of handle
313 reference position
314 vector indicating deviation from reference position
321 direction vector of posture of handle
322 direction vector from handle to object
323 vector indicating deviation of up, right, left or right
411 traction force (repulsion)
412 force toward up, down, left or right
501 screen
511 upper edge portion
512 right edge portion
513 left edge portion
514 lower edge portion
515 central portion
800 game device
801 storage unit
802 input receiving unit
803 generation unit
804 display unit
805 distance calculation unit
806 move calculation unit
807 correction unit
808 update unit
851 object information
852 viewpoint information
853 sight line information
854 cursor information
855 attention area information
951 moving direction of viewpoint position
952 display area
960 attention area
1101 rotation direction of sight line direction

### DESCRIPTION OF PREFERRED EMBODIMENTS

Embodiments according to the present invention will be described below. The embodiments in which the present invention is implemented will be described using an information processing device for a game for easy understanding. However, the following embodiments are for the purpose of explaining the present invention, not limiting the scope of the invention of the present application. Therefore, a person skilled in the art could employ embodiments in which each or all of the elements of the following embodiments are substituted by their equivalents, and these embodiments are also included within the scope of the present invention.

### First Embodiment

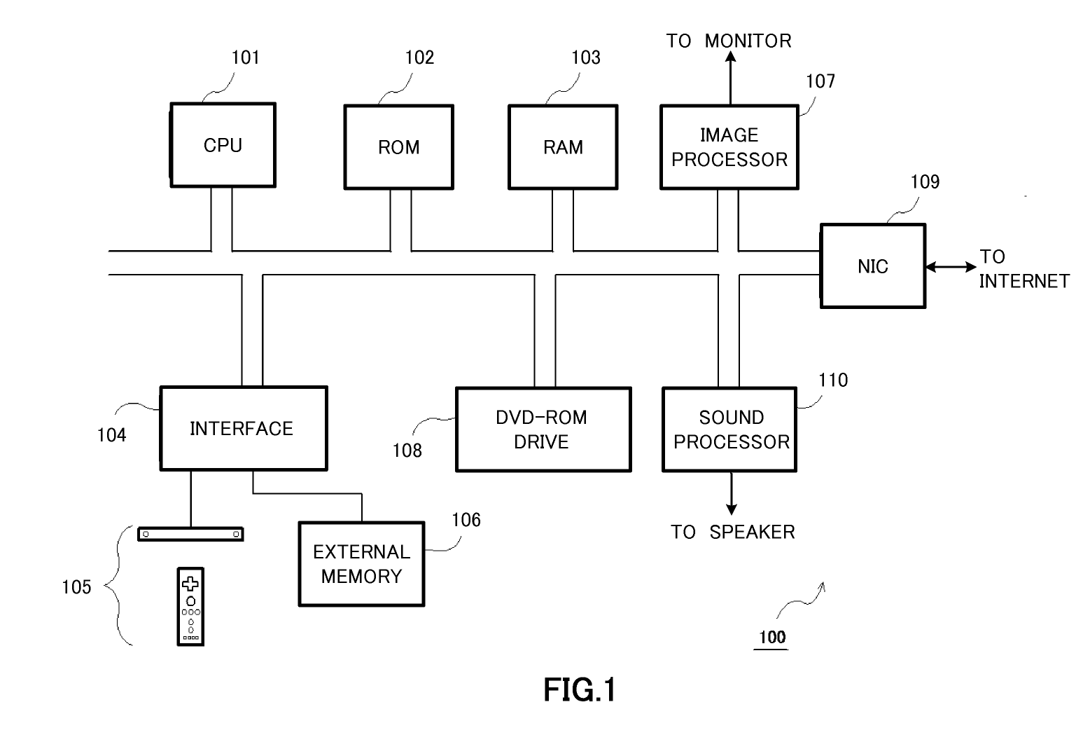

FIG. 1 is a diagram illustrating a schematic configuration of a typical information processing device that functions as a device according to an embodiment of the present invention by executing a program.

An information processing device 100 includes a CPU (Central Processing Unit) 101, a ROM 102, a RAM (Random Access Memory) 103, an interface 104, a controller 105, an external memory 106, an image processor 107, a DVD-ROM (Digital Versatile Disk-ROM) drive 108, a NIC (Network Interface Card) 109, a sound processor 110 and a microphone 111.

When a DVD-ROM storing a program and data for a game is mounted to the DVD-ROM drive 108 and the information processing device 100 is powered on, the program is executed to realize a game device of the present embodiment.

The CPU 101 controls the whole operation of the information processing device 100, and is connected to each component, sends control signals and data to the component and receives them from the component. The CPU 101 can use an ALU (Arithmetic Logic Unit) (not shown) to perform an arithmetic operation such as four arithmetic operations, logical operation such as logical addition, logical multiplication and logical negation, and a bit operation such as bit addition, bit multiplication, bit inversion, bit shift and bit rotation, relative to a high-speed accessible storage area called a register (not shown). The CPU 101 may be configured to perform saturate operation such as four arithmetic operations for multimedia processing and vector operation such as trigonometric function at a high speed. The CPU 101 may be realized with a coprocessor.

The ROM 102 stores an IPL (Initial Program Loader) that is executed immediately after power is turned on and the IPL is executed to read out a program recorded in a DVD-ROM into the RAM 103, and then execution by the CPU 101 starts. The ROM 102 stores an operating system program necessary for operation control of the whole information processing device 100 and various data.

The RAM 103 temporarily stores data and a program, and has a program and data read out from the DVD-ROM and other data necessary for a game procedure and chat communication. The CPU 101 provides the RAM 103 with a variable area and acts the ALU directly to values stored in the variable area to perform an operation, or after storing values stored in the RAM 103 into the register, and then performs operation to the register and writes down the operation results on a memory.

The controller 105 connected through the interface 104 receives an operation input by a user while the user is playing a game. Details on the controller will be described later.

The external memory 106 removably connected through the interface 104 rewritably stores data such as data representing a game-playing situation (e.g. scores of the past), data representing a stage of progress of a game, and data of a log (record) of chat communication in a game using a network. The user can appropriately record these data into the external memory 106 by inputting an instruction through the controller 105.

The DVD-ROM mounted to the DVD-ROM drive 108 stores a program for implementing a game, and image data and voice data accompanying with the game. By the control of the CPU 101, the DVD-ROM drive 108 performs read-out processing to the DVD-ROM mounted thereto to read out a necessary program and data from the DVD-ROM and temporarily stores them into the RAM 103 and the like.

After data read out from the DVD-ROM is processed by an image operation processor (not shown) within the CPU 101 or the image processor 107, the processed data is stored in a frame memory (not shown) within the image processor 107. Image information recorded in the frame memory is converted to a video signal at a predetermined synchronous timing and is output to a monitor (not shown) connected to the image processor 107. This enables various image displays.

The image operation processor can perform superposition operation of two-dimensional images, transmission operation such as alpha blending and various saturation operations at a high speed.

If a virtual space is configured as a three-dimensional space, it is also possible to perform an operation at a high speed in which polygonal information which is disposed in the virtual three-dimensional space and to which various texture information is added is rendered by a Z-buffer method, thereby obtaining a rendering image of a polygon, disposed in the virtual space, looked down from a predetermined viewpoint position in a predetermined sight line direction.

By cooperating of the CPU 101 and image operation processor, a character string can be drawn as a two-dimensional image to a frame memory or can be drawn to each surface of the polygon, according to font information defining a shape of a character.

The NIC 109 connects the information processing device 100 to a computer communication network (not shown) such as the Internet and is composed of a modem such as a modem pursuant to 10BASE-T/100BASE-T standard used for constructing a LAN (Local Area Network), an analog modem for connecting to the Internet with the use of a telephone line, an ISDN (Integrated Services Digital Network) modem, an ADSL (Asymmetric Digital Subscriber Line) modem, a cable modem for connecting to the Internet with the use of a cable television line as well as an interface (not shown) that interfaces these and the CPU 101.

The sound processor 110 converts voice data read out from the DVD-ROM to an analog voice signal and outputs it from a speaker (not shown) connected thereto. Under the control of the CPU 101, it generates sound effects and music data to be emitted during a game operation and outputs voice corresponding to them from the speaker.

If the voice data recorded in the DVD-ROM is MIDI data, the sound processor 110 refers to sound source data therein and converts the MIDI data to PCM data. If the voice data is compressed data such as data in ADPCM form or Ogg Vorbis form, it is extracted to be converted to PCM data. The PCM data is subjected to a D/A (Digital/Analog) conversion at the timing according to its sampling frequency and is output to the speaker, thereby enabling voice output.

The information processing device 100 can be connected to the microphone 111 through the interface 104. In this case, an analog signal from the microphone 111 is subjected to A/D conversion at a suitable sampling frequency to be converted to a digital signal in PCM form, so as to enable processing such as mixing in the sound processor 110.

In addition to these, the information processing device 100 may be configured to do the same function as that of the ROM 102, the RAM 103, the external memory 106, or the DVD-ROM mounted to the DVD-ROM drive 108, by using a high-capacity external storage device such as a hard disk.

The information processing device 100 described above is, what is called, “a television game device for consumers”. However, the present invention can be implemented by a device as long as the device performs an image processing of displaying a virtual space. Therefore, the present invention can be implemented in various computers such as a cell phone, a portable game device, a karaoke device and a common business-use computer.

For example, a common computer includes a CPU, a RAM, a ROM, a DVD-ROM drive and an NIC, similarly to the information processing device 100 and also includes an image processing unit having a simpler function than that of the information processing device 100. A common computer also has a hard disc as an external storage device, and can use a flexible disc, a magnetic optical disc, a magnetic tape and the like. It uses a keyboard or a mouse as an input device instead of the controller 105.

The present embodiment employs the controller 105 that can measure various parameters such as a position and a posture in the real space.

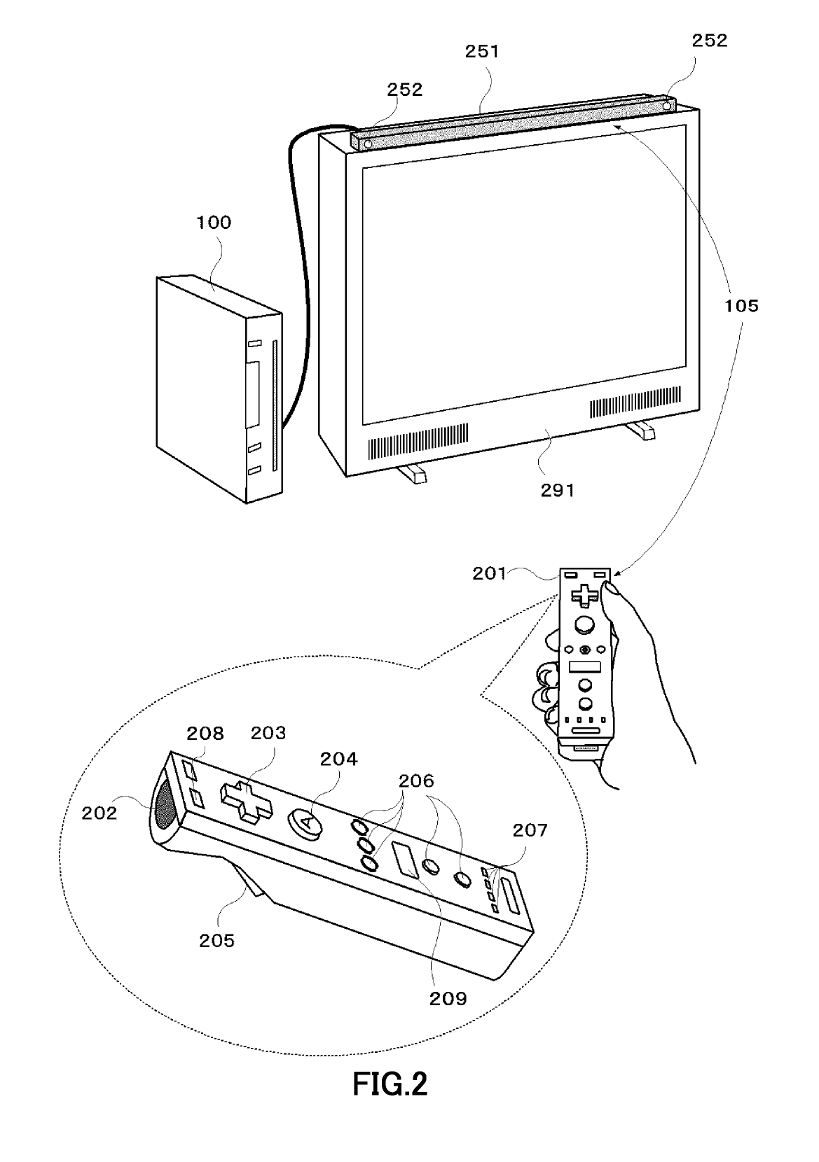

FIG. 2 is a diagram illustrating appearances of the controller 105 and information processing device 100 that can measure various parameters such as a position and a posture in the real space. Description will be made below with reference to FIG. 2.

The controller 105 is composed of a grip module 201 and a light-emitting module 251. The grip module 201 is wirelessly connected to the information processing device 100 so that they can communicate with each other. The light-emitting module 251 is connected to the information processing device 100 by wire so that they can communicate with each other. Voice and images, which are processing results by the information processing device 100, are output and displayed by a television device 291.

The grip module 201 has a similar appearance of a remote controller of the television device 291 and on its front edge a CCD camera 202 is disposed.

The light-emitting module 251 is fixed to the top of the television device 291. A light-emitting diode 252 is disposed on the both ends of the light-emitting module 251 and emits light by power supply from the information processing device 100.

The CCD camera 202 of the grip module 201 captures an image of the state of the light-emitting module 251.

A captured image information is transmitted to the information processing device 100, and the CPU 101 of the information processing device 100 acquires a position of the grip module 201 relative to the light-emitting module 251 based on a position of the light-emitting diode 252 in the captured image.

The grip module 201 also has an acceleration sensor, an angular acceleration sensor and a tilt sensor embedded therein, thereby enabling a posture of the grip module 201 itself to be measured. This measurement result is also transmitted to the information processing device 100.

A cross key 203 is disposed on the upper surface of the grip module 201 and a user can perform various direction instruction inputs by pressing the cross key 203. An A-button 204 and various buttons 206 are also disposed on the upper surface and a user can perform an instruction input associated with each of the buttons.

A B-button 205 is disposed on the bottom surface of the grip module 201. Together with a dent formed on the bottom surface of the grip module 201, the B-button 205 imitates a trigger of a gun or a reacher. Typically, an instruction input for letting off the gun or gripping by the reacher in the virtual space is performed by using the B-button 205.

An indicator 207 on the upper surface of the grip module 201 presents an operational state of the grip module 201 and its wireless communication state with the information processing device 100 to the user.

A power button 208 on the upper surface of the grip module 201 switches on or off the operation of the grip module 201 itself, and the grip module 201 runs on an internal battery (not shown).

A speaker 209 is also disposed on the upper surface of the grip module 201 and outputs voice through a voice signal input by the voice processing unit 110. A vibrator (not shown) is disposed inside of the grip module 201, and the presence or absence of vibration and its intensity can be controlled according to an instruction from the information processing device 100.

The following description will be made, using the controller 105 composed of the grip module 201 and light-emitting module 251, on the premise that a position and a posture of the grip module 201 in the real world are measured. However, the present invention is not limited to the aforementioned mode and includes the case where the position and posture of the controller 105 are measured in the real world by using an ultrasonic wave, infrared communication or a GPS (Global Positioning System), for example.

(Summary of a Game)

Next, a game to which the present invention is applied will be summarized. One of the purposes of the game is to grip an object placed in a virtual space with a reacher and transfer the object from one place to another. In the present game, a player's gripping a controller corresponds to a character's gripping a handle of a reacher.

A reacher is a stick-shaped “arm” that can extend beyond an area where a person's hand can reach, has a “hand” on its front edge, can carry an object by “sticking” the hand to the object and can stop the “sticking”. Therefore, a rod having a birdlime on its front end and can get a distant object with the birdlime is also considered a reacher. For easy understanding, a state where an object is carried by a reacher will be referred to as “a reacher grips an object” according to a common expression.

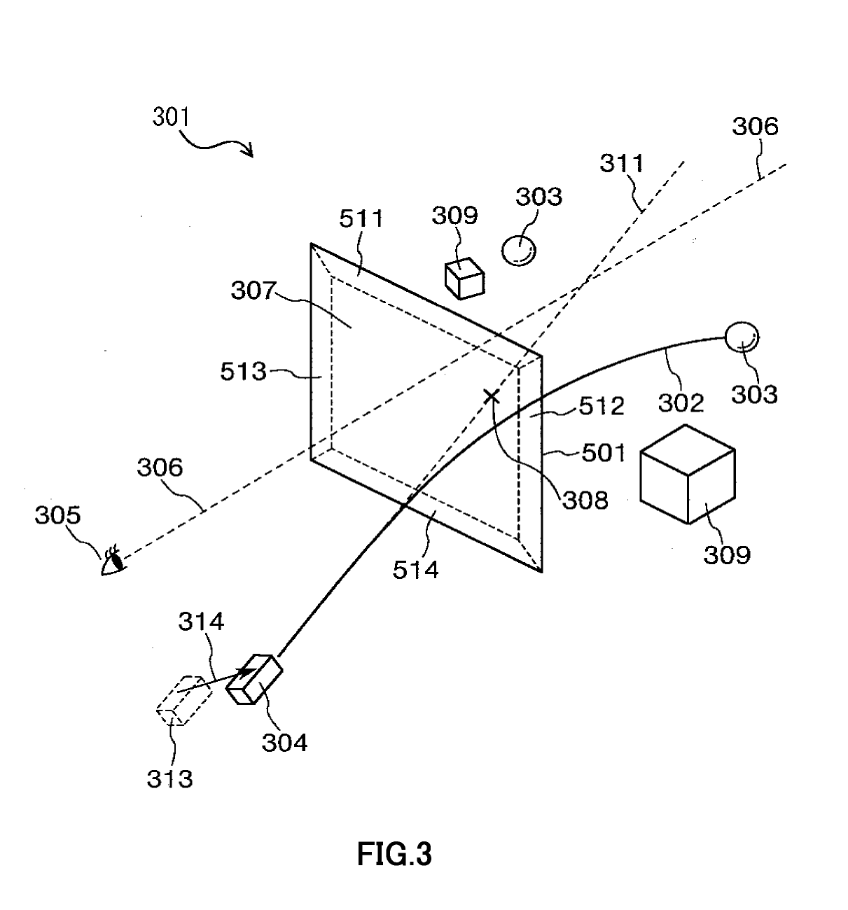

FIG. 3 is a diagram illustrating a correspondence relationship between a virtual space in such a game and a real world. Description will be made below with reference to FIG. 3.

In a virtual space 301, a reacher 302 and an object 303 to be gripped by the reacher 302 are placed. The reacher 302 is composed of a handle 304 and a traction beam, and most part of the entire length of the reacher 302 is the traction beam. A “traction beam” is employed as a “setting” in a cartoon or animation and can grip and draw an object with its front end.

The traction beam of the reacher 302 in the present game has a stick shape. When the traction beam is not gripping any object, the traction beam extends from an injection port of one end of the handle 304 of the reacher 302 to collide against an object (including various obstacle objects such as a wall) in a half line manner. Therefore, a posture of the handle 304 of the reacher 302 defines an injection direction of the traction beam of the reacher 302.

When a player in the real world changes a position and posture of the grip module 201, a position and posture of the handle 304 of the reacher 302 accordingly changes. In the present game, the position and posture of the grip module 201 are measured and an instruction is given to the handle 304 of the reacher 302. Then, based on the instruction of “a change of the posture of the grip module 201”, the position and posture of the handle 304 of the reacher 302 changes in the virtual space 301.

The player fixes the grip module 201 to a place where the grip module 201 is the easiest to be gripped at the start of the game. Then, the handle 304 of the reacher 302 is placed in the most natural posture at a position determined relative to a viewpoint 305 and a sight line 306 placed within the virtual space 301.

At this time, the grip module 201 is placed at “a reference position” relative to the player in the real world, the handle 304 of the reacher 302 is placed at “a reference position” relative to the viewpoint 305 and sight line 306 in the virtual world 301.

The “reference position” is decided relative to the viewpoint 305 and sight line 306 in the virtual space, which corresponds to that the position where the player holds the grip module 201 in the most natural posture is decided relative to the position of the eyes of the player.

The viewpoint 305 and sight line 306 in the virtual space 301 correspond to eyes of a character (which is also called a subjective viewpoint) in the virtual space 301 that is operated (performed) by the player or correspond to eyes that see the character from behind (which is called an objective viewpoint) and these eyes correspond to the eyes of the player. Therefore, the reference position of the handle 304 of the reacher 302 is typically at the right and under the viewpoint 305 or at the left and under the view point 305, depending on the player's dominant hand.

In the direction of the sight line 306 from the viewpoint 305, a virtual projection plane 307 is orthogonal to the sight line 306. The state of the virtual space 301 is presented to the player as an image obtained by perspectively projecting, the object 303 and the traction beam of the reacher 302 to be displayed on the screen, on the projection plane 307.

As a method of perspective projection, one-point concentration type projection is typical, using a point where a straight line connecting the viewpoint 305 and the object 303 intersects with the projection plane 307. However, a parallel projection may be employed in which the view point 305 is placed at an infinite distance and a point, at which a line that passes through the object 303 and is parallel to the sight line 306 intersects with the projection plane 307, is used.

As described above, since the handle 304 of the reacher 302 is placed at the right (or left) of and below the viewpoint, the point is perspectively projected outside the area displayed on the screen within the projection plane 307 in a normal state. Therefore, usually, the handle 304 of the reacher 302 is not displayed on the screen.

When the player changes the position and posture of the grip module 201 from the reference position in the real world, the information processing device 100 refers to their measurement results and moves the position and posture of the handle 304 of the reacher 302 from the reference position by the corresponding amount (typically the same amount as that of the real world).

Therefore, the position and posture of the handle 304 relative to the viewpoint 305 and sight line 306 move together with the position and posture of the grip module 201. The player uses the grip module 201 as an object to be operated to change the position and posture of the handle 304 of the reacher 302 as an object to be instructed.

The player changes the position and posture of the grip module 201 to operate the traction beam extending from handle 304 of the reacher 302 so as to collide against a desired object 303. Then, when the player presses the B-button 205 of the grip module, the front end of the reacher 302 grips the object 303.

As described above, the traction beam of the reacher 302 extends from an injection point at one end of the handle 304 of the reacher 302 toward the position of the gripped object 303 as a target point. Therefore, pressing the B-button 205 sets a target position of the traction beam, which corresponds to the state where a trigger is pulled in a shooting game. According to the present embodiment, while the B-button 205 is not pressed, the position of the object 303 against which the traction beam of the reacher 302 collides for the first time is set to the target position of the traction beam.

After that, a motion simulation of the object 303 starts. External forces applied on the object 303 are as follows:

(1) a gravity force in the virtual space, which is typically applied downward.

(2) a force in the direction of the straight line connecting the handle 304 of the reacher 302 (or the viewpoint 305) and the object 303 in the virtual space, which corresponds to, what is called, a traction force and a repulsion. These forces correspond to a force to approach the player and a force to move away from the player on the screen display and are decided by a distance between the object 303 and the handle 304 of the reacher 302 (or the viewpoint 305), that is, extension and contraction of the reacher 302.

(3) a force in the direction orthogonal to the straight line connecting the handle 304 of the reacher 302 (or the viewpoint 305) and the object 303 in the virtual space, which corresponds to a force applied toward the up, down, left or right on the screen display and is decided by a bending direction and a bending amount of the reacher 302.

(4) a force applied in the opposite direction of the moving direction of the object 303 while the object 303 is moving, which corresponds to, what is called, a dynamical friction force.

(5) a force applied in the opposite direction of an external force by the same amount of the external force while the object 303 is static, which corresponds to, what is called, a static friction force.

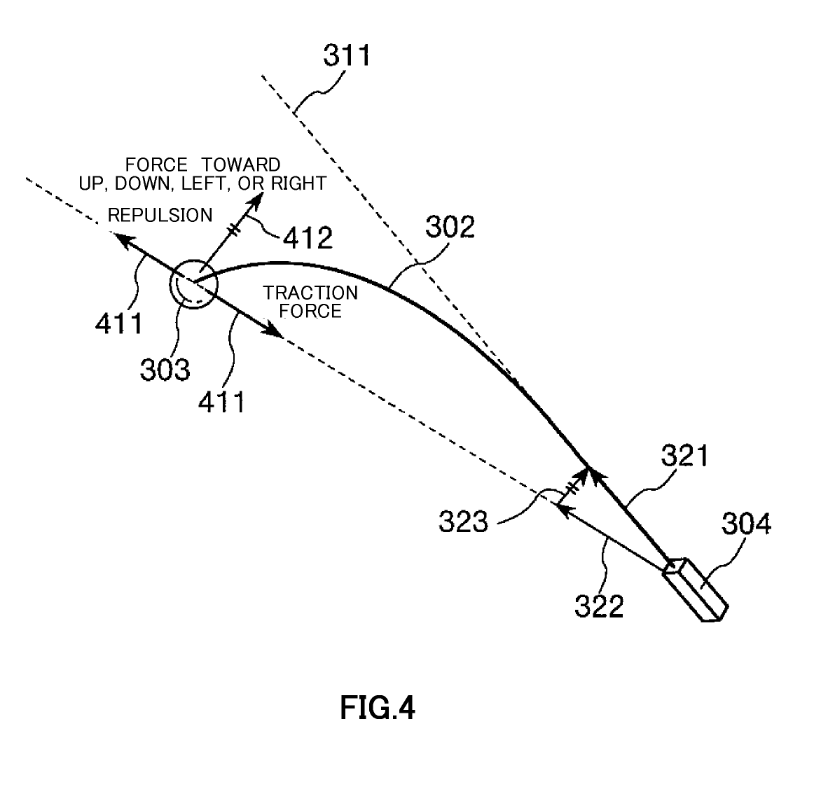

Next, extension, contraction and bending of the reacher 302 will be described in details. FIG. 4 is a diagram illustrating a position relationship between the handle 304 of the reacher 302 and the object 303, as well as directions of forces.

As illustrated in FIG. 4, the reacher 302 gripping the object 303 extends, contracts, or bends when the player changes the position and posture of the handle 304. Meanwhile, as described above, while the traction beam of the reacher 302 is not gripping anything, the traction beam goes straight from the injection port disposed on one end of the handle 304.

A posture direction 311 of the handle 304 of the reacher 302 will be defined as “a direction in which the traction beam goes straight from the injection port disposed at one side of the handle 304, on the assumption that the traction beam of the reacher 302 is not gripping anything”.

Generally, when the traction beam of the reacher 302 is gripping the object 303, the traction beam bends due to the weight of the object 303, causing a deviation between the posture direction 311 of the handle 304 of the reacher 302 and the direction from the handle 304 toward the object 303.

Therefore, the traction beam is injected tangentially along the posture direction 311 of the handle 304 and then smoothly bends to make a curved line to the object 303. As such a curved line, various curved lines can be used, such as a spline curve obtained by spline interpolation and a circular arc. In this case, it is easy to calculate the direction of the traction beam at the object 303, as, what is called, an open end.

A distance between the handle 304 (or the viewpoint 305) and the object 303 at the moment the reacher 302 starts to grip the object 303, can be deemed to be a natural length of the reacher 302. By comparing the natural length with a distance between the handle 304 and the object 303 in the current virtual space, a traction force (repulsion) 411 corresponding to a spring can be simulated. That is to say, the simulation can be easily performed, assuming the generation of a traction force (repulsion represented by an absolute value if the sign is negative) 411 having a value that is obtained such that the natural length is subtracted from the distance and the resulting value is multiplied by a predetermined integer constant.

Meanwhile, a force 412 to move the object 303 toward up, down, left or right is generated by a deviation between the posture of the handle 304 of the reacher 302 (the extending direction of the traction beam when it is not gripping the object 303) and the direction from the handle 304 (or the viewpoint 305) toward the object 303.

That is to say, the direction of the force toward up, down, left or right 412 is a direction of a vector 323 that is obtained by subtracting, a direction vector indicating a direction from the handle 304 (or the viewpoint 305) toward the object 303, from a direction vector 321 indicating the posture direction 311 of the handle 304. A magnitude of the force 412 is proportional to a magnitude of the vector 323.

In line with a real physical phenomenon, assuming that the force toward up, down, left or right 412 is further proportional to the distance between the handle 304 (or the viewpoint 305) and the object 303, the simulation can be easily performed.

If external forces applied to an the object 303 can be calculated, the CPU 101 can calculate acceleration applied to the object 303 and update the position of the object 303 by calculating the gravity force, static friction force and dynamic friction force as a normal physical simulation. In this way, the object 303 is moved.

When the object 303 has moved to a desired position, the player removes his/her finger from the B-button 205, thereby releasing a pressing operation. By this, the reacher 302 stops gripping the object 303 and the traction beam returns to its original state to extend in the posture direction 311 of the handle 304 of the reacher 302.

In the state where the reacher 302 is gripping the object 303, if another object (hereinafter, referred to as “an obstacle”) 309 exits on the route of the traction beam, the state where the object 303 is being gripped is released. By the release, the shape of the traction beam returns from the bent shape to the half line shape.

(Posture of Handle of Reacher)

The shape of the traction beam of the reacher 302 is a half line and indicates the posture direction 311 of the handle 304 when the traction beam is not gripping the object 303. Since the traction beam bends when the reacher grips the object 303, another method is necessary to present to the player the posture direction 311 of the handle 304. Then, a cursor (an indication sign) is used.

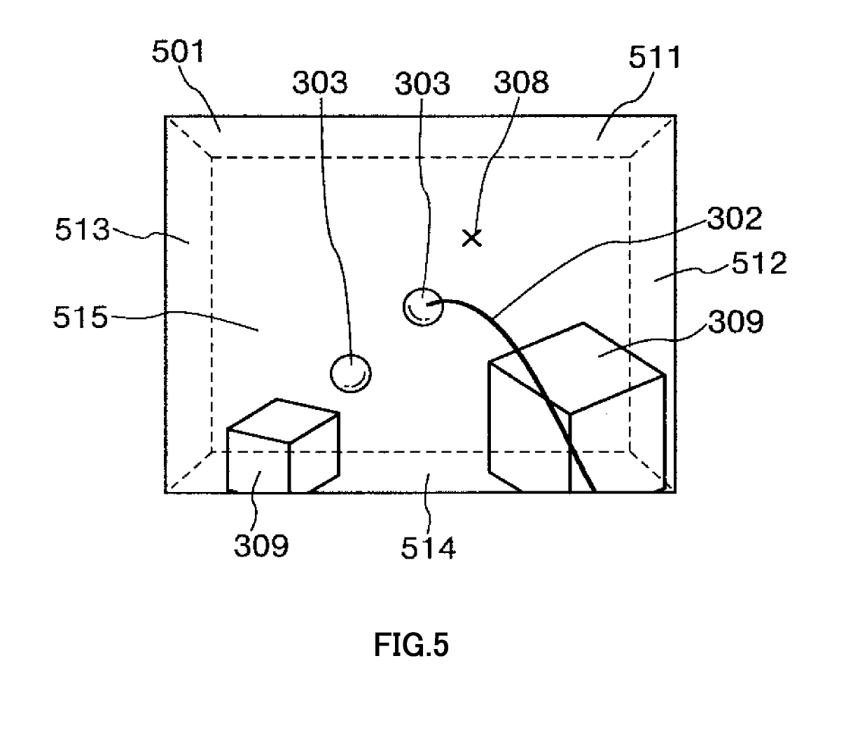

FIG. 5 is a diagram illustrating a screen on which the cursor (indication sign), reacher, and objects are displayed. Description will be made below with reference to FIG. 5.

FIG. 5 illustrates the state where the reacher 302 is gripping the object 303, in which the direction 311 of the handle 304 is not the same as the direction of the traction beam within a screen 501. That is, a cursor 308 is displayed on a straight line in the direction 311 of the handle 304, but is not on the traction beam of the reacher 302.

An image displayed on the screen 501 represents a figure of an object projected to the projection plane 307. A position of the cursor 308 within the projection plane 307 may be a position of the point where the half line extending from the handle 304 in the posture direction 311 of the handle 304 intersects with the projection plane 307. This enables the player to properly understand the direction of the handle 304 of the reacher 302, only by watching the screen.

In the state where the reacher 302 is gripping the object 303, the direction 311 of the handle 304 is the same as the direction of the traction beam. The cursor 308 is displayed on the traction beam of the reacher 302.

According to the embodiment in which the cursor 308 is displayed, the following variation can be applied to an operation technique of the reacher 302. That is, while the B-button 205 is not being pressed, the traction beam of the reacher 302 is not injected, and when the position and posture of the handle 304 changes, a display position of the cursor 308 within the screen 501 accordingly changes.

According to the present embodiment, the display position of the cursor 308 is a position where the posture direction 311 of the handle 304 of the reacher 302 intersects with the projection plane 307. However, the display position of the cursor 308 may be the position where a straight line passing through “a position of a surface of another object 303 against which the posture direction 311 of the handle 304 of the reacher 302 first collides” and the viewpoint 305 intersects with the projection plane 307. In this case, the player can feel like that he/she points at an object in a room using a laser pointer.

When the player presses the B-button 205, the traction beam is injected from the injection port of the handle 304 of the reacher 302. Then, if the object 303 against which the traction beam first collides is movable, the traction beam attracts this. When a mode of pointing at an object using a laser pointer is employed as the display position of the cursor 308, the object 303 displayed with being overlapped with the cursor 308 becomes an attracted object 303, which is easy to understand for the player. The move of the attracted object 303 is the same as described above.

In some cases, it is a bother for the player to continue to press the B-button 205. In such cases, a mode can be employed in which when the player presses and then releases the B-button 205, the traction beam is injected and attracts the object 303 to be moved to a desired position, and after that when the player presses and releases again the B-button 205, the traction beam of the reacher 302 is deleted and the object 303 is released.

“A start to receive an instruction input” and “an end to receive the instruction input” correspond to “a start to press the B-button 205” and “an end to press the B-button 205”, respectively. Alternatively, “a start to receive an instruction input” and “an end to receive the instruction input” correspond to “a press and release of the B-button 205 in a state where the traction beam is not injecting” and “a press and release of the B-button 205 in a state where the traction beam is injecting”, respectively.

Which operation mode is employed can be properly changed depending on the player's level of proficiency and game's type. Assignment of a button to issue an instruction input can be properly changed depending on application, for example, employing the A-button 204 instead of the B-button 205.

(Move of Viewpoint Position)

In the above description, the viewpoint position 305 does not change. However, in some cases, the object 303 cannot be moved to a desired position only by changing the position of the handle 304 of the reacher 302 relative to the viewpoint 305. In such cases, there may be a method in which the player operates the cross key 203 to move the viewpoint 305 in the virtual space. However, in the present game, a method that is more intuitive for the player is employed.

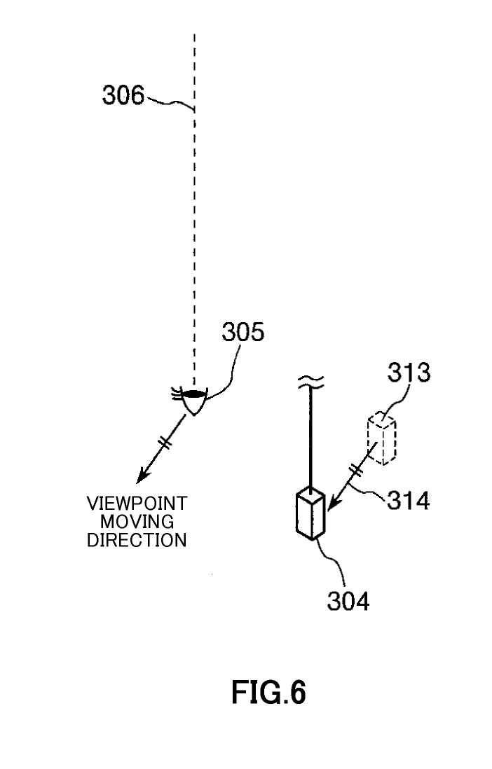

FIG. 6 is a diagram illustrating the relationship between the position of the handle 304 of the reacher and the moving direction of the viewpoint 305. Description will be made below with reference to FIG. 6.

At the start of the game, a reference position 313 of the handle 304 of the reacher 302 is set relative to the viewpoint 305 and sight line 306 in the virtual space 301.

After that, when the player changes the position of the grip module 201, the position of the handle 304 of the reacher 302 accordingly changes.

Then, the viewpoint is moved to the direction of a vector 314 that is obtained by subtracting a position vector of the reference position 313 from a position vector of the current position of the handle 304.

The vector 314 (or a vector obtained by multiplying the vector 314 by a constant) is set to a velocity vector of the moving velocity of the viewpoint 305, and the viewpoint 305 is moved by an amount obtained by multiplying a predetermined unit time by the velocity vector.

Alternatively, a predetermined plane surface (it typically corresponds to “a ground” in the virtual space 301, but not limited to this) may be assumed in the virtual space 301, and a component of the vector 314 (or a vector obtained by multiplying the vector 314 by a constant) that is parallel to the predetermined plane surface may be the velocity vector of the moving velocity.

In addition to these, taking into consideration a vector of an external force, or, an acceleration vector (in these cases, only a component parallel to the ground is typically considered) applied on a character including the viewpoint 305, the move of the viewpoint 305 itself can be simulated.

When the player watching the television device 291 moves the grip module 201 backward (toward his/her back), the character having the viewpoint 305 in the virtual space 301 accordingly moves backward. Then, the reacher 302 gripping the object 303 extends to some extent, and generally an attraction force toward the character having the viewpoint 305 is applied to the object 303, and then the object 303 moves forward from the back of the screen.

When the player moves the grip module 201 forward (so as to approach to the television device 291), the character having the viewpoint 305 in the virtual space 301 moves forward. Then, the reacher 302 gripping the object 303 contracts to some extent, and generally a repulsion to move away from the character having the viewpoint 305 is applied to the object 303, and then the object 303 moves backward from the front of the screen.

The traction force and repulsion caused by extension and contraction of between the handle 304 of the reacher 302 does not always need to be assumed. An instruction input to change the length of the reacher 302 may be performed by the player with the use of the A-button 204 or various buttons 206.

The aforementioned modes make the followings possible:

(1) moving the character having the viewpoint 305 forward or backward in the virtual space 301;

(2) changing the position and posture of the handle 304 of the reacher 302 relative to the viewpoint 305 and sight line 306 in the virtual space 301;

(3) gripping or releasing the object 303 by using the front end of the flexible reacher 302 extending from the handle 304 in the virtual space 301. These functions can move the object 303 from one point to another point in the virtual space 301.

New functions to be added to the aforementioned functions according to the principle of the present invention will be described below.

(Control of Sight Line Direction)

In the aforementioned mode, the player often wants to change an orientation of the character, that is, the direction of the sight line 306. Since moving the grip module 201 forward or backward in the real space enables the character to move forward or backward, it is preferable to change the sight line direction by a similar easy operation.

According to the present embodiment, the cursor 308 is displayed on the screen 501, thereby indicating the posture of the handle 304. The position of the cursor 308 within the screen 501 can be easily changed by the player's changing the posture of the grip module 201. Then, the CPU 101 changes the orientation of the character, that is, the direction of the sight line 306, based on the position of the cursor 308 displayed on the screen 501.

As illustrated in FIG. 5, the screen 501 is divided to five areas: an upper edge portion 511, a right edge portion 512, a left edge portion 513, a lower edge portion 514 and a central portion 515. The player instructs the move of the direction of the sight line 306 by changing the posture of the grip module 201 as will be described below.

(a) When intending to move the sight line 306 upward, the player changes the posture of the grip module 201 so that the cursor 308 is displayed on the upper edge portion 511.

(b) When intending to move the sight line 306 rightward, the player changes the posture of the grip module 201 so that the cursor 308 is displayed on the right edge portion 512.

(c) When intending to move the sight line 306 leftward, the player changes the posture of the grip module 201 so that the cursor 308 is displayed on the left edge portion 513.

(d) When intending to move the sight line 306 downward, the player changes the posture of the grip module 201 so that the cursor 308 is displayed on the lower edge portion 514.

(e) When the sight line 306 is in a desired direction, the player changes the posture of the grip module 201 so that the cursor 308 is displayed on the central portion 515.

In other words, while the indication sign (cursor 308) is displayed within a predetermined display area (upper edge portion 511, right edge portion 512, left edge portion 513 or lower edge portion 514) of the screen 501, the CPU 101 moves the direction of the sight line 306 to the direction of up, down, left or right that is associated with each of the display areas. The indication sign (cursor 308) is displayed outside a predetermined display area (a central portion 515) of the screen 501, the CPU 101 stops the move of the direction of the sight line 306.

The CPU 101 identifies which area of the screen 501 the position of the cursor 308 is in every unit time (for example, every cycle of vertical synchronization interrupt). Then, if necessary, the CPU 101 changes the direction of the sight line 306 to the direction assigned to the area by the amount assigned to the area.

After the aforementioned processing has changed the direction of the sight line 306, it is preferable that the CPU 101 updates the posture direction 311 of the handle 304 of the reacher 302 in the virtual space so as not to change the display position of the cursor within the screen 501.

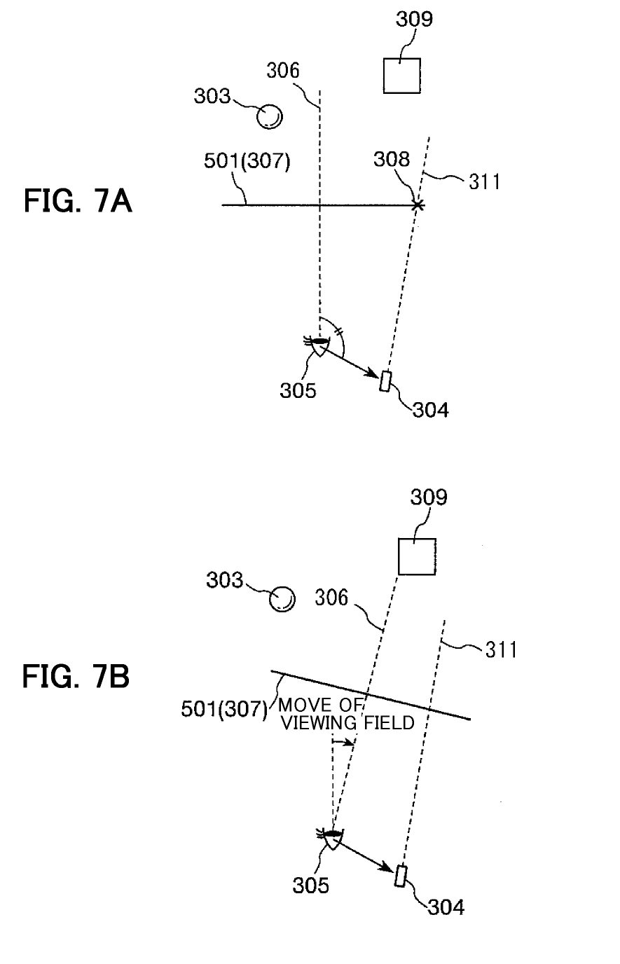

FIGS. 7A to 7C are diagrams illustrating a processing for moving the direction of the sight line 306.

(1) First, the CPU 101 acquires the position and posture of the handle 304 of the reacher 302 relative to the viewpoint 305 and sight line 306 before changing the direction of the sight line 306 (FIG. 7A).

(2) Next, the CPU 101 changes the direction of the sight line 306 around the viewpoint 305 to change the orientation of the character (FIG. 7B).

(3) Then, the CPU 101 updates, the position and posture of the handle 304 of the reacher 302 that correspond to the changed viewpoint 305 and sight line 306, to the position and posture acquired in (1) (FIG. 7C). The position and posture of the handle 304 of the reacher 302 change relative to the virtual space 301.

Before and after the move of the direction of the sight line 306, the position and posture of the handle 304 of the reacher 302 maintain the same values relative to the viewpoint 305 and sight line 306.

For example, if the player wants the character to face right, the player changes the posture of the grip module 201 so that the cursor 308 moves to the right edge portion 512.

Then, the direction of the sight line 306 starts to move rightward, and by holding the posture of the grip module 201 steady, the orientation of the character (direction of the sight line 306) is updated. Even if the orientation of the character is changing rightward little by little, the display position of the cursor 308 does not change within the screen 501.

When the orientation of the character (direction of the sight line 306) has changed to a desired orientation, the player may change the posture of the grip module 201 so that the cursor 308 returns to within the central portion 515 of the screen 501. Such a highly intuitive operation easily enables the orientation of the character to be changed.

A width of each of the upper edge portion 511, right edge portion 512, left edge portion 513 and lower edge portion 514 and a moving amount of the direction of the sight line 306 per unit time can be properly changed depending on the application field and the player's level of proficiency. The CPU 101 may change the moving amount per unit time so as to become smaller as closer to the central portion 515 and to become bigger as closer to the edge of the screen 501.

When the player (the direction of the sight line 306) looks up or down, a suitable upper or lower limit may be provided. When the direction of the sight line 306 reaches the upper or lower limit, further change of the direction of the sight line 306 may be prohibited. Alternatively, various limits can be set, such as limiting the change of the sight line 306 to only left or right direction.

A manner of dividing the edge of the screen 501 is not limited in the present invention. For example, an area of the screen 501 may be divided such that divided areas spread out in a fan-like form from the center of the screen 501 and a moving amount in a direction from the center of the screen per unit time may be assigned to each of the areas, thereby enabling a move in an oblique direction.

Next, a functional configuration of a game device 800 according to the present embodiment will be described.

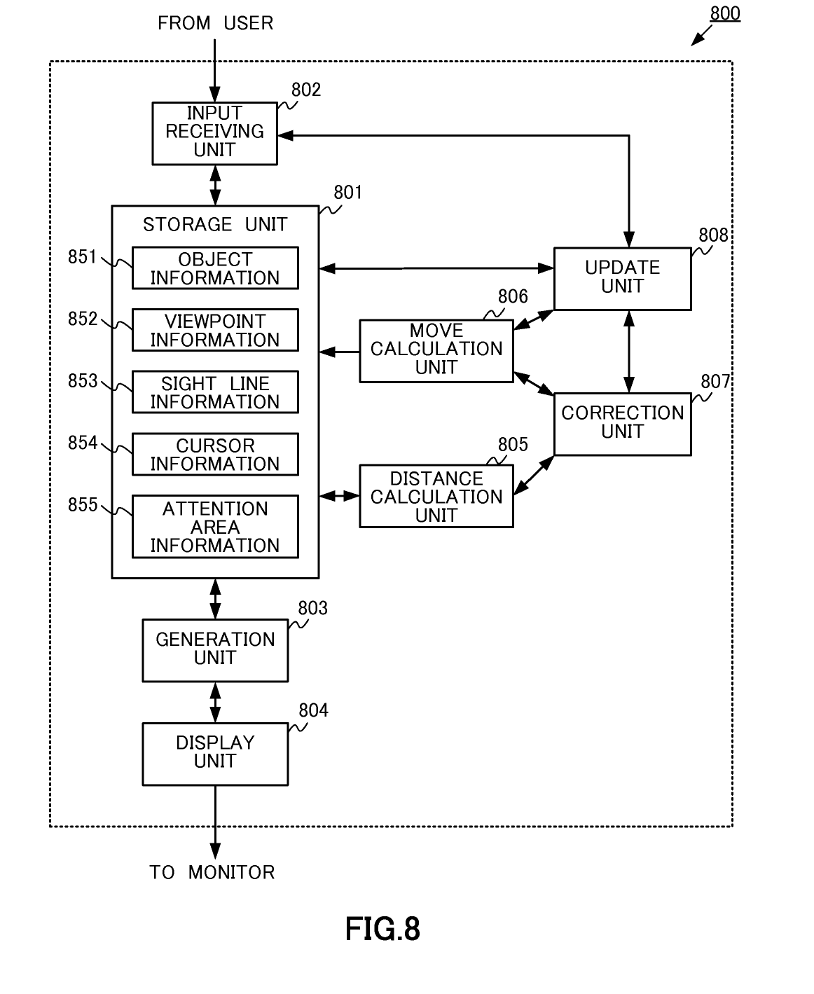

FIG. 8 is a diagram illustrating a functional configuration of a game device 800. The game device 800 includes a storage unit 801, an input receiving unit 802, a generation unit 803, a display unit 804, a distance calculation unit 805, a move calculation unit 806, a correction unit 807 and an update unit 808.

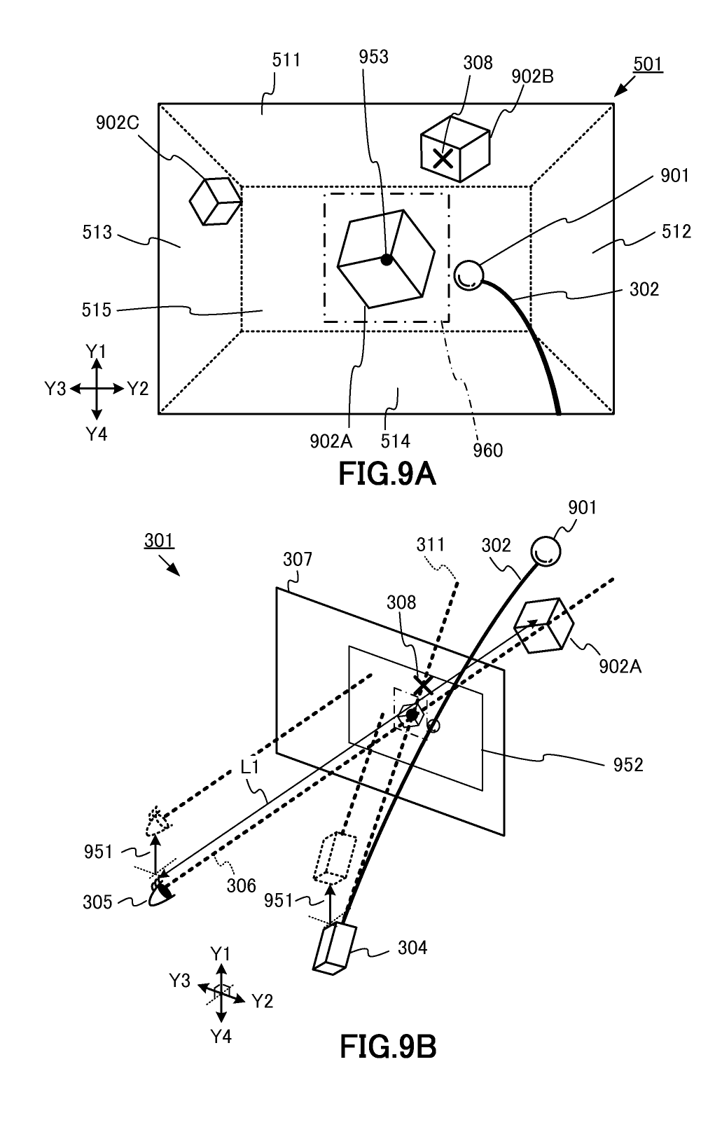

FIG. 9A is an example of a screen 501 displayed on a monitor. The screen 501 displays an object 901 gripped by the reacher 302, as well as objects 902A, 902B and 902C as the aforementioned objects. FIG. 9B is a diagram illustrating a virtual space 301, in which the screen 501 illustrated in FIG. 9A is displayed.

The storage unit 801 stores object information 851, viewpoint information 852, sight line information 853, cursor information 854 and attention area information 855. The CPU 101 and RAM 103 work together to function as the storage unit 801. The external memory 106 may be used instead of the RAM 103.

The object information 851 is information that indicates a position of the object 303 placed in the virtual space 301. If a plurality of the objects 303 is placed in the virtual space 301, the storage unit 801 stores information indicating a position of each of the objects 303, as the object information 851. In the virtual space 301, a global coordinate system is defined using a Cartesian coordinate system or a polar coordinate system. A position is indicated by using a coordinate value of the global coordinate system. For example, when the reacher 302 moves with gripping the object 303, the CPU 101 calculates a change amount of the position of the object 303. Then, the CPU 101 changes the position of the object 303 by the calculated change amount and updates the object information 851.

The viewpoint information 852 is information indicating a position of the viewpoint 305 placed in the virtual space 301 and is indicated by a coordinate value of the global coordinate system. The CPU 101 calculates a change amount of the position of the viewpoint 305 according to the change of the position of the grip module 201 in the real space. Then, the CPU 101 changes the position of the viewpoint 305 by the calculated change amount and updates the viewpoint information 852.

The sight line information 853 is information indicating the direction of the sight line 306 placed in the virtual space 301 and is indicated by a direction vector of the global coordinate system. The CPU 101 calculates a change amount of the sight line 306 according to the change of the posture of the grip module 201 in the real space. Then, the CPU 101 changes the direction of the sight line 306 by the calculated change amount and updates the sight line information 853.

According to the present embodiment, the position of the viewpoint 305 and the direction of the sight line 306 both are variable. However, the position of the viewpoint 305 may be fixed and only the direction of the sight line 306 may be variable. Alternatively, the direction of the sight line 306 may be fixed and the position of the viewpoint 305 may be variable.

The cursor information 854 is information indicating a position of the cursor 308 within the screen 501. For example, in the screen 501, a two-dimensional coordinate system is defined, setting the upper left corner to an origin, the rightward direction from the origin to a positive direction of the X-axis, and the downward direction from the origin to a negative direction of the Y-axis. The position of the cursor 308 within the screen 501 is indicated by a coordinate value of the two-dimensional coordinate system. The CPU 101 calculates a change amount of the position of the cursor 308 according to the change of the position and posture of the grip module 201 in the real space. Then, the CPU 101 changes the position of the cursor 308 by the calculated change amount and updates the cursor information 854.

The attention area information 855 is information indicating a position of an attention area 960 set within the screen 501. The attention area 960 is an area that is presumed, by the CPU 101 based on, e.g. an instruction input from a user, to attract much attention from the player and is set within the screen 501. The screen area that is presumed to attract much attention from the player is typically a certain area adjacent to the center of the screen 501. However, the position, size, shape and so on of the screen area that attracts much attention from player are presumed to change depending on a game content, a game development and an position of the object 303. The CPU 101 can properly change the position, size, shape and so on of the attention area 960 depending on the game content, game development and position of the object 303. The entire screen 501 can be set to the attention area 960.

According to the present embodiment, the attention area 960 is fixed to a rectangle whose center of gravity is a center point 953 of the screen 501. The embodiment in which the position of the attention area 960 is variable will be described later.

The input receiving unit 802 receives various instruction inputs from the user who is operating the grip module 201. For example, the input receiving unit 802 receives from the player an instruction input such as a move instruction input to move the position of the viewpoint 305 and the direction of the sight line 306, an selection instruction input to select an arbitrary object 303 as an object to be operated and an operation instruction input to grip or release the object 303 with the reacher 302. Then, the input receiving unit 802 updates the viewpoint information 852, sight line information 853 and cursor information 854 stored in the storage unit 801, based on the received instruction input.

For example, when the user operates the grip module 201 to change the position and posture of the grip module 201, the CPU 101 calculates a change amount of the position of the viewpoint 305 and/or a change amount of the direction of the sight line 306 according to the change of position and posture of the grip module 201. Then, the CPU 101 changes the position of the viewpoint 305 and/or the direction of the sight line 306 by the calculated change amount and updates the viewpoint information 852 and/or sight line information 853. The CPU 101, RAM 103 and controller 105 work together to function as the input receiving unit 802.

An embodiment can be also employed in which the user uses an operation device operated with his/her both hands (what is called a game pad), instead of a stick-shaped operation device gripped by the user with a hand (typically with one hand) such as the grip module 201. An embodiment can be also employed in which the user uses an operation device in which various operations are performed by contacting a touch pen to a touch panel mounted on a monitor.

The generation unit 803 generates an image by projecting the virtual space 301 to the projection plane 307 placed in the virtual space 301 from the position of the viewpoint 305 in the direction of the sight line 306. That is, by the control of the CPU 101, the image processor 107 generates an image representing the virtual space 301 viewed from the position of the viewpoint 305 in the direction of the sight line 306. The generated image may include an image representing the object 303 (projection image) depending on the position of the viewpoint 305 or the direction of the sight line 306.

According to the present embodiment, the generation unit 803 draws an image representing the virtual space 301 overlapped with an image representing the cursor 308 that is set based on the position and posture of the grip module 201. The player can easily recognize the direction 311 of the handle 304 based on the position of the cursor 308. However, the generation unit 803 may not draw an image representing the cursor 308. The CPU 101, the RAM 103 and the image processor 107 work together to function as the generation unit 803.

According to the present embodiment, the projection plane 307 is placed perpendicular to the direction 311 of the handle 304.

The display unit 804 displays the image generated by the generation unit 803 on the monitor. That is, by the control of the CPU 101, the image processor 107 displays the screen 501 as illustrated in, e.g. FIG. 9A on the monitor. In FIG. 9A, the reacher 302 extends toward the back of the virtual space 301 displayed on the screen 501 and is gripping the object 901. The CPU 101, RAM 103 and image processor 107 work together to function as the display unit 804.

The distance calculation unit 805 calculates a distance “L1” between the position of the object 303 drawn within the attention area 960 in the virtual space 301 and the position of the viewpoint 305 in the virtual space 301. The CPU 101, RAM 103 and image processor 107 work together to function as the distance calculation unit 805.

The move calculation unit 806 calculates the moving direction and moving distance per unit time of the position of the viewpoint 305 stored in the viewpoint information, based on a move instruction input that the input receiving unit 802 receives from the user. The CPU 101 and RAM 103 work together to function as the move calculation unit 806.

More specifically, the CPU 101 calculates the moving direction and moving distance as follows. First, the CPU 101 determines whether or not the cursor 308 is included within a predetermined area of the screen 501 on which the generated image is displayed (or the generated image).

This predetermined area is an area composed of at least one of the upper edge portion 511, right edge portion 512, left edge portion 513 and lower edge portion 514 of the screen 501.

When the player changes the position and posture of the grip module 201, the position and posture of the handle 304 of the reacher 302 also changes. The CPU 101 obtains a moving direction of the position of the handle 304 based on the change of the position and posture of the grip module 201 and moves the position of the handle 304 in the direction of a vector 951. The CPU 101 also moves the position of the viewpoint 305 in the direction of the vector 951.

The CPU 101 sets the direction of the vector 951 indicating the moving direction of the viewpoint 305 (or handle 304) to as follows:

(1) upward direction of the projection plane 307, “Y1” if the cursor 308 is within the upper edge portion 511;

(2) rightward direction of the projection plane 307, “Y2” if the cursor 308 is in the right edge portion 512;

(3) leftward direction of the projection plane 307, “Y3” if the cursor 308 is in the left edge portion 513; and

(4) downward direction of the projection plane 307, “Y4” if the cursor 308 is in the lower edge portion 514.

For example, in FIG. 9A, the cursor 308 is drawn in the upper edge portion 511 of the screen 501, and the CPU 101 determines that the cursor 308 is included within the upper edge portion 511 set to a predetermined area. The CPU 101 sets the upward direction of the screen 501, “Y1”, to the moving direction and accordingly changes the position of the viewpoint 305.

If a game pad including buttons each specifying up, down, left or right is used instead of the grip module 201, the CPU 101 sets the direction of the vector 951 indicating the moving direction of the viewpoint 305 (or handle 304) to as follows:

(1) upward direction of the projection plane 307, “Y1”, if an up button is pressed;

(2) rightward direction of the projection plane 307, “Y2”, if a right button is pressed;

(3) leftward direction of the projection plane 307, “Y3”, if a left button is pressed; and

(4) downward direction of the projection plane 307, “Y4”, if a down button is pressed.

When the position of the viewpoint 305 moves, the CPU 101 moves the position of a display area 952 set within the projection plane 307. A portion included within the display area 952 of the whole image projected to the projection plane 307 becomes an image of the screen 501 displayed on the monitor.

Therefore, if the cursor 308 is within the upper edge portion 511, the image within the screen 501 scrolls in the upward direction of the projection plane 307, “Y1”; if the cursor 308 is within the right edge portion 512, it scrolls in the rightward direction of the projection plane 307, “Y2”; if the cursor 308 is within the left edge portion 513, it scrolls in the leftward direction of the projection plane 307, “Y3”; and if the cursor 308 is within the lower edge portion 514, it scrolls in the downward direction of the projection plane 307, “Y4”.

In the description below, moving the position of the display area 952 within the projection plane 307 will be also referred to as “scrolling the screen 501”.

Furthermore, the CPU 101 sets, a length of the vector 951 indicating the moving direction of the viewpoint 305 (or handle 304), i.e. a moving distance of the point of the viewpoint 305, to a predetermined value ΔLfix. In other words, if the cursor 308 is included within any of the upper edge portion 511, right edge portion 512, left edge portion 513, lower edge portion 514, the CPU 101 sets a moving distance per unit time of the position of the viewpoint 305 to a predetermined value ΔLfix. Moving the point of the viewpoint 305 by the predetermined value ΔLfix corresponds to scrolling the screen 501 by a scroll amount specified by the predetermined value ΔLfix and its scroll speed does not change.

However, the CPU 101 may set the moving distance of the viewpoint 305 per unit time to be not a fixed value but a variable value. For example, a two-dimensional coordinate system is defined, setting the upper left corner of the screen 501 to an origin, the rightward direction from the origin to a positive direction of the X-axis, and the downward direction from the origin to a positive direction of the Y-axis. The CPU 101 performs the following (1) to (4) processing depending on the situation.

(1) If the cursor 308 is included in the upper edge portion 511, the CPU 101 sets a greater moving distance per unit time of the position of the viewpoint 305 for a smaller Y-coordinate value of the position of the cursor 308 within the screen 501, that is, the case where the cursor 308 is placed at a more upper position of the screen 501.

(2) If the cursor 308 is included within the right edge portion 512, the CPU 101 sets a greater moving distance per unit time of the position of the viewpoint 305 for a greater X-coordinate value of the position of the cursor 308 within the screen 501, that is, the case where the cursor 308 is placed at a more rightward position.

(3) If the cursor 308 is included within the left edge portion 513, the CPU 101 sets a greater moving distance per unit time of the position of the viewpoint 305 for a smaller X-coordinate value of the position of the cursor 308 within the screen 501, that is, the case where the cursor 308 is placed at a more leftward position.

(4) If the cursor 308 is included in the lower edge portion 514, the CPU 101 sets a greater moving distance per unit time of the position of the viewpoint 305 for a greater Y-coordinate value of the position of the cursor 308 within the screen 501, that is, the case where the cursor 308 is placed at a more downward position of the screen 501.

The scroll speed of the screen 501 is not constant but variable.

According to the present embodiment, the scroll direction of the screen 501 is four directions: up, down, left and right. However, the scroll direction is not limited to these four directions and may be scrolled in any direction. For example, the CPU 101 can divide the change amount of the position of the cursor 308 into a left and right component and an up and down component of the screen 501, and can scroll the screen 501 in a left and right direction by an amount corresponding to the left and right direction of the change amount of the position of the cursor 308 and in an up and down direction by an amount corresponding to the up and down amount of the change amount of the position of the cursor 308.

The correction unit 807 corrects the moving distance calculated by the move calculation unit 806 based on the distance “L1” obtained by the distance calculation unit 805. At this time, the correction unit 807 performs the correction so that the corrected moving distance ΔL monotonically decreases relative to the distance “L1” obtained by the distance calculation unit 805. The CPU 101 and RAM 103 work together to function as the correction unit 807.

More specifically, the CPU 101 corrects the moving distance of the position of the viewpoint 305 as follows. The CPU 101 performs the correction so that the smaller the distance “L1” between the position of the object 303 (object 902A in FIG. 9A) placed within the attention area 960 in the virtual space 301 and the position of the viewpoint 305 in the virtual space 301 becomes, the smaller the moving distance of the position of the viewpoint 305 becomes. In other words, the moving distance per unit time ΔL of the position of the viewpoint 305 obtained by the correction monotonically decreases relative to the distance “L1”.

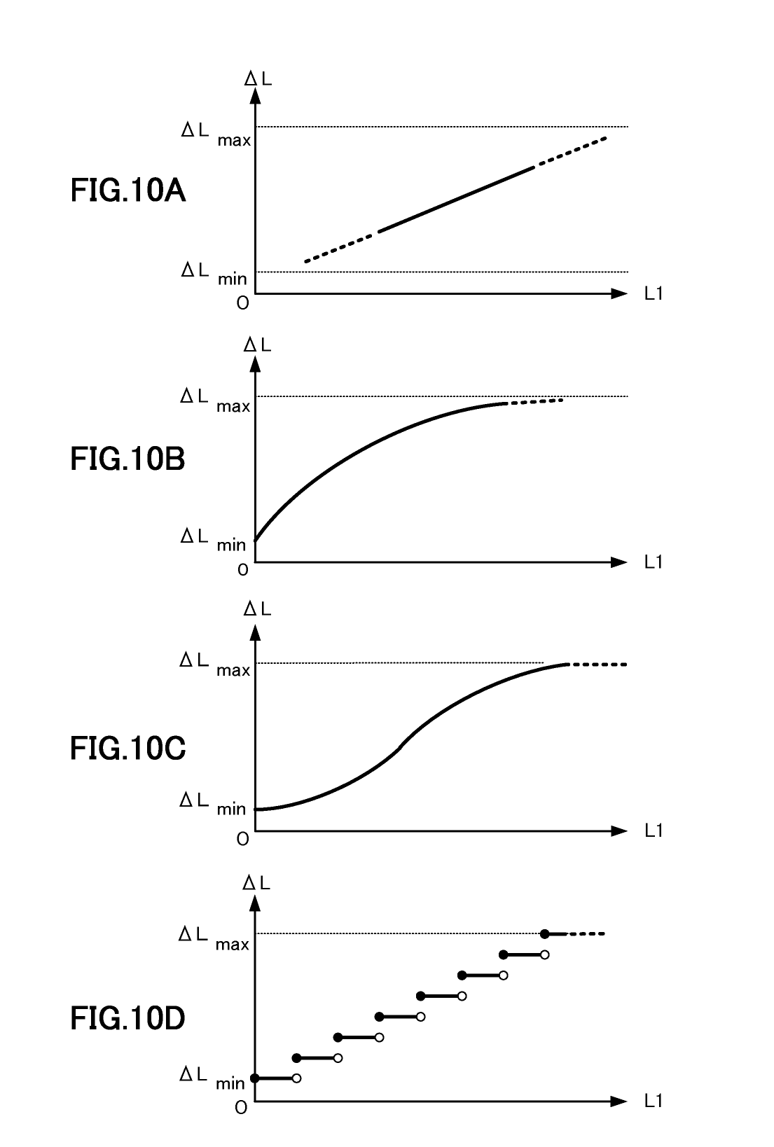

For example, FIGS. 10A to 10D are diagrams illustrating an example of a relationship of the distance “L1” between the object 303 placed within the attention area 960 and the viewpoint 305, to the moving distance ΔL of the position of the corrected viewpoint 305. If, as the present embodiment, the moving distance calculated by the move calculation unit 806 is fixed to the predetermined value ΔLfix, a correction function for the correction unit 807 to correct the position of the viewpoint 305 is represented by a function of each of FIGS. 10A to 10D.

In FIG. 10A, the CPU 101 increases the moving distance ΔL of the position of the viewpoint 305 in proportion to the distance “L1”. Once the moving distance ΔL becomes the maximum value ΔLmax at a certain distance (not shown), the moving distance ΔL is constantly fixed to the maximum value ΔLmax for a distance greater than the certain distance.

In FIG. 10B, the CPU 101 reduces an increasing rate of the moving distance ΔL as the distance “L1” becomes greater. The moving distance ΔL finally converges to the maximum value ΔLmax.

In FIG. 10C, the CPU 101 changes the increasing rate of the moving distance ΔL, where the increasing rate is a real number greater or equal to 0.

In FIG. 10D, the CPU 101 changes the moving distance ΔL with the use of a step function. The moving distance ΔL may tend to increase on the whole as the distance “L1” increases and there may be a section in which the moving distance ΔL is constant (a section in which the increasing rate is zero).

The CPU 101 may use any of the functions illustrated in FIGS. 10A to 10D and may combine these functions. Further, a function can be freely set as long as the function fulfills the relationship in which the smaller the distance “L1” becomes, the smaller the moving distance ΔL becomes.

The moving direction per unit time and moving distance ΔL per unit time obtained as described above correspond to a moving direction per unit time and a moving distance per unit time of the position of the viewpoint 305, respectively. The CPU 101 moves the position of the viewpoint 305 in the calculated moving direction by the corrected moving distance per unit time.

Assuming that the moving distance per unit time is fixed to the fixed value ΔLfix and the correction unit 807 does not correct this value, the screen 501 always scrolls at a constant speed. However, according to the present embodiment, the further from the viewpoint 305 the object 303 placed within the attention area 960 of the screen 501 becomes, the greater the moving distance ΔL per unit time of the position of the viewpoint 305 becomes and the greater (faster) the screen 501 scrolls. On the contrary, the closer to the viewpoint 305 the object 303 placed within the attention area 960 of the screen 501 becomes, the smaller the moving distance ΔL per unit time of the position of the viewpoint 305 becomes and the smaller (slower) the screen 501 scrolls.

Generally, it is presumed that the player often plays the game while watching around the center of the screen 501 more often than watching other portions. In addition, if a plurality of objects 303 exits in the screen 501, it is presumed that the objects 303 placed closer to the center attract more attention from the player. Therefore, the position of the attention area 960 may be fixed to around the center of the screen 501. Alternatively, the position of the attention area 960 may be variable, which will be described later in detail.

It is presumed that the closer to the viewpoint 305 the object 303 becomes, that is, the bigger the object 303 displayed on the screen 501 becomes, the more attention attracts from the player. In other words, it is possible that the degree of the attention from the player in the entire screen 501 is nonuniformly distributed. In such a state, if the screen 501 scrolls widely (fast), it is possible that the player cannot follow the change of an image or becomes dizzy, and the image may become difficult to be seen by the player. However, in the game device 800 according to the present embodiment, if the object 303 placed closer to the viewpoint 305 compared with other objects is drawn within the attention area 960 of the screen 501, the scroll amount of the screen 501 is reduced, thereby the screen scrolling little by little. Therefore, the visibility of the screen 501 for the player can be improved. The game device 800 according to the present embodiment also can suppress frequent occurrences of scroll processing caused by the move of the viewpoint 305, thereby reducing a burden of scroll processing on the game device 800.

The update unit 808 updates the viewpoint information 852 so as to move the position of the viewpoint 305 in the calculated moving direction by the corrected moving distance ΔL per unit time. The CPU 101 and RAM 103 work together to function as the update unit 808.

The CPU 101 can change the direction of the sight line 306, instead of the position of the viewpoint 305.

In other words, the move calculation unit 806 may obtain the rotation direction and rotation angle per unit time of the direction of the sight line 306 stored in the sight line information 853, based on a move instruction input and so on that the input receiving unit 802 receives from the user. The correction unit 807 may correct the rotation angle of the direction of the sight line 306 so that the corrected rotation angle monotonically decreases relative to the distance “L1” calculated by the distance calculation unit 805. Then, the update unit 808 may move the direction of the sight line 306 in the obtained rotation direction by the corrected rotation angle per unit time so as to update the sight line information 853.

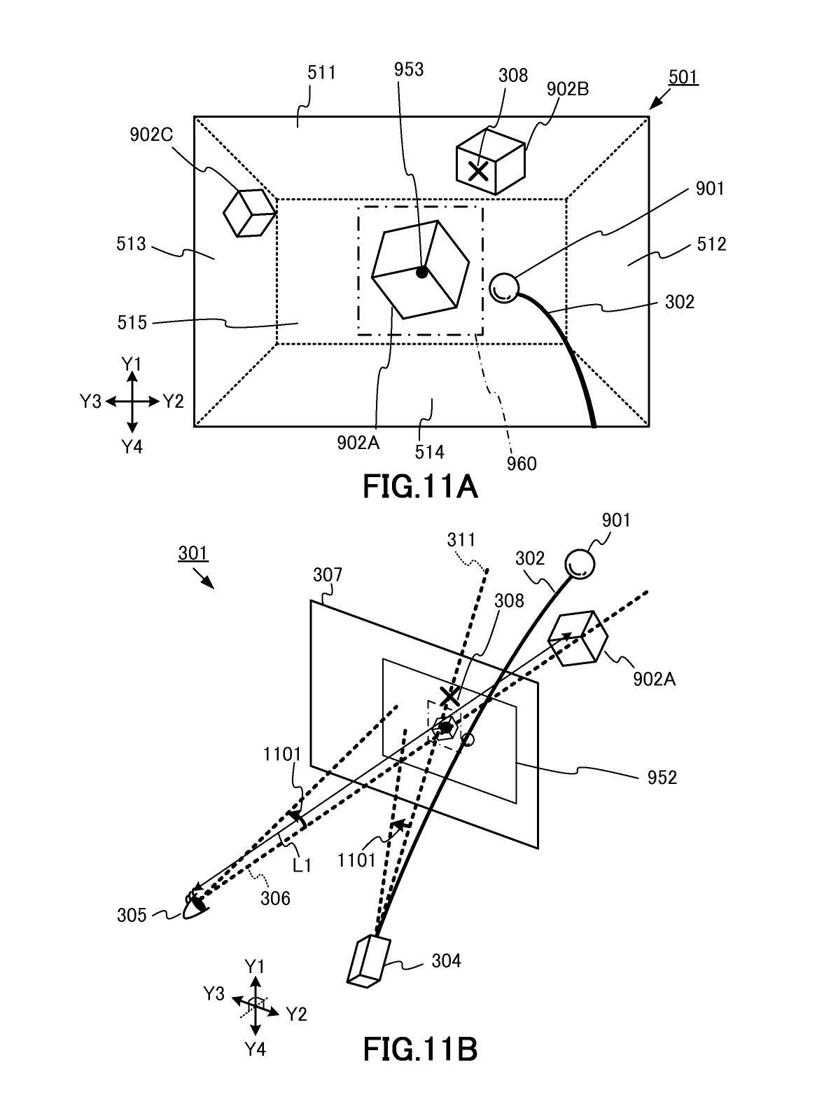

FIG. 11A is an example of the screen 501 displayed on a monitor.

FIG. 11B is a diagram illustrating a virtual space 301 in which the screen 501 illustrated in FIG. 11A is displayed.

When the player changes the position and posture of the grip module 201, the position and posture of the handle 304 of the reacher 302 also changes. The CPU 101 obtains the rotation direction of the direction of the handle 304 based on the change of the position and posture of the grip module 201, and moves (rotates) the direction of the handle 304 to the direction of an angle 1101. The CPU 101 also moves (rotates) the direction of the sight line 306 to the direction of the angle 1101.

The CPU 101 moves the direction of the sight line 306 (or handle 304) as follows:

(1) upward direction of the projection plane 307, “Y1”, if the cursor 308 is within the upper edge portion 511;

(2) rightward direction of the projection plane 307, “Y2”, if the cursor 308 is in the right edge portion 512;

(3) leftward direction of the projection plane 307, “Y3”, if the cursor 308 is in the left edge portion 513; and

(4) downward direction of the projection plane 307, “Y4”, if the cursor 308 is in the lower edge portion 514.

For example, in FIG. 11A, the cursor 308 is drawn within the upper edge portion 511 of the screen 501. The CPU 101 determines that the cursor 308 is included within a predetermined area, that is, the upper edge portion 511. The CPU 101 changes the direction of the sight line 306 so that the upward direction “Y1” of the screen 501 is the moving direction.

When the direction of the sight line 306 moves, the CPU 101 moves the orientation of the projection plane 307. For example, when the position of the viewpoint 305 is not changed and the direction of the sight line 306 is changed, an image within the screen 501 scrolls as follows.

If the cursor 308 is in the upper edge portion 511, the image scrolls in the upward direction “Y1” of the projection plane 307 as it looks up.

If the cursor 308 is in the right edge portion 512, the image scrolls in the rightward direction “Y2” of the projection plane 307 as it turns around to the right.

If the cursor 308 is in the left edge portion 513, the image scrolls in the leftward direction “Y3” as it turns around to the left.

If the cursor 308 is in the lower edge portion 514, the image scrolls in the downward direction “Y4” as it looks down.

Furthermore, the CPU 101 sets, a length of a vector 1101 indicating the rotation direction of the sight line 306 (or the handle 304), that is, the rotation angle per unit time of the direction of the sight line 306, to a predetermined value ΔDfix. In other words, if the cursor 308 is included within any of the upper edge portion 511, right edge portion 512, left edge portion 513 and lower edge portion 514, the CPU 101 sets the rotation angle per unit time of the sight line 306 to the predetermined value ΔDfix.

However, the CPU 101 may set the rotation angle of the sight line 306 to be a variable value, not a fixed value. For example, a two-dimensional coordinate system is defined, setting the upper left corner of the screen 501 to an origin, the rightward direction from the origin to a positive direction of the X-axis, and the downward direction from the origin to a positive direction of the Y-axis. The CPU 101 performs the following processing (1) to (4):

If the cursor 308 is included in the upper edge portion 511, the CPU 101 sets a greater rotation angle per unit time of the direction of the sight line 306 for a smaller Y-coordinate value of the position of the cursor 308 within the screen 501, that is, the case where the cursor 308 is placed at a more upper position of the screen 501.

(2) If the cursor 308 is included within the right edge portion 512, the CPU 101 sets a greater rotation angle per unit time of the position of the sight line 306 for a greater X-coordinate value of the position of the cursor 308 within the screen 501, that is, the case where the cursor 308 is placed at a more rightward position of the screen 501.

(3) If the cursor 308 is included within the left edge portion 513, the CPU 101 sets a greater rotation angle per unit time of the direction of the sight line 306 for a smaller X-coordinate value of the position of the cursor 308 within the screen 501, that is, the case where the cursor 308 is placed at a more leftward position of the screen 501.

(4) If the cursor 308 is included in the lower edge portion 514, the CPU 101 sets a greater rotation angle per unit time of the direction of the sight line 306 for a greater Y-coordinate value of the position of the cursor 308 within the screen 501, that is, the case where the cursor 308 is placed at a more downward position of the screen 501.

The scroll speed of the screen 501 is not constant but variable.

The correction unit 807 corrects the rotation angle calculated by the move calculation unit 806, based on the distance “L1” obtained by the distance calculation unit 805. At this time, the correction unit 807 corrects the rotation angle so that the corrected rotation angle ΔD monotonically decreases relative to the distance “L1” obtained by the distance calculation unit 805.

The CPU 101 may use a function in which the moving distance ΔL of the position in any of functions illustrated by FIGS. 10A to 10D is replaced by the rotation angle ΔD, or may use a combination of these functions. A function can be freely set as long as the function fulfills a relationship in which the smaller the distance “L1” becomes, the smaller the rotation angle ΔD becomes.

The rotation direction and the rotation angle per unit time ΔD obtained as described above are a moving direction per unit time of the direction of the sight line 306 and a moving angle per unit time of the direction of the sight line 306, respectively. The CPU 101 moves the direction of the sight line 306 in the calculated rotation direction by the corrected rotation angle, per unit time.

The update unit 808 updates the sight line information 853 so as to move the direction of the sight line 306 in the calculated rotation direction by the corrected rotation angle ΔD, per unit time.

Similarly to the case where the position of the viewpoint 305 is changed, in changing the direction of the sight line 306, the further from the viewpoint 305 the object 303 placed within the attention area 960 of the screen 501 becomes, the greater the rotation angle ΔD of the direction of the sight line 306 becomes and the greater the screen 501 scrolls. On the contrary, the closer to the viewpoint 305 the object 303 placed within the attention area 960 of the screen 501 becomes, the smaller the rotation angle ΔD of the direction of the sight line 306 becomes and the screen 501 scrolls little by little.

The embodiment in which either of the position of the viewpoint 305 and the direction of the sight line 306 is moved may be employed, or the embodiment in which both of them are moved can be employed.

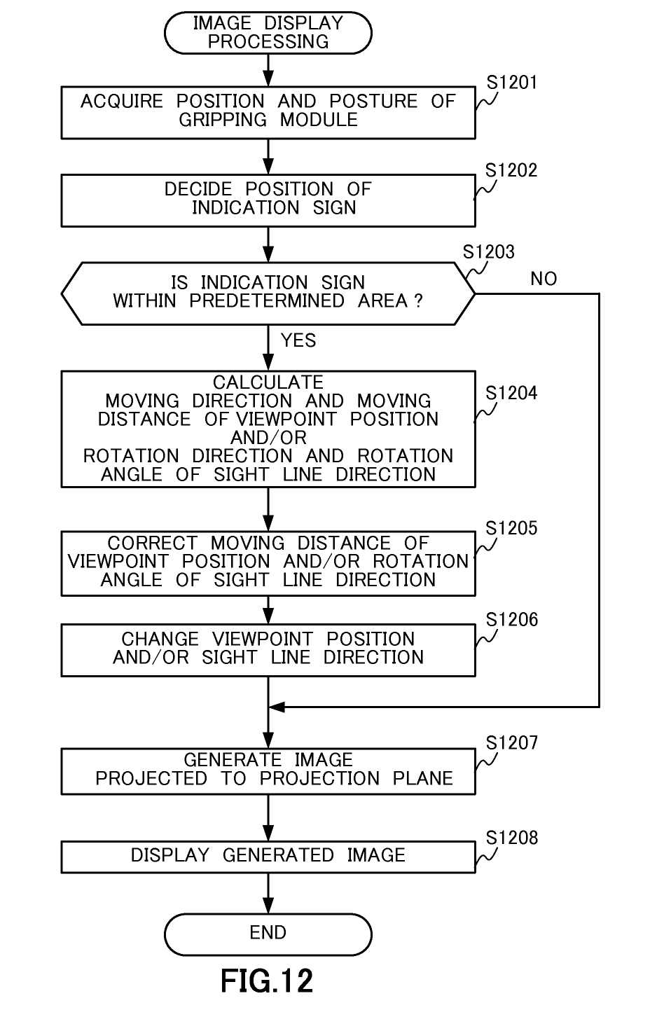

Next, an image display processing performed by the aforementioned units of the game device 200 will be described with reference to a flow chart of FIG. 12.

According to the present embodiment, the attention area 960 has a rectangular shape and is fixed to the center position of the screen 501.

First, the CPU 101 acquires information indicating the position and posture of the grip module 201 in the real space from the controller 105 (Step S1201).

The CPU 101 obtains the position and posture of the handle 304 based on the position and posture of the grip module 201 acquired in Step S1201 and decides the position of the cursor 308 within the screen 501 (Step S1202).

Specifically, the CPU 101, for example, associates a position of the grip module 201 in the real space with a position of the handle 304 in the virtual space 301 in an one-to-one manner and sets, the position in the virtual space 301 corresponding to the position of the grip module 201 acquired in Step S1201, to the position of the handle 304. The posture of the grip module 201 acquired in Step S1201 is set to the posture of the handle 304. Then, the CPU 101 sets, a position where the straight line 311 indicating the direction of the handle 304 intersects with the projection plane 307, to the position of the cursor 308.

The CPU 101 updates the cursor information 854 so as to set the position decided in Step S1202 to be a new position of the cursor 308.

The CPU 101 determines whether or not the position of the cursor 308 decided in Step S1202 is within a predetermined area of the screen 501 (Step S1203).

For example, all of the aforementioned upper edge portion 511, right edge portion 512, left edge portion 513 and lower edge portion 514 are set to the predetermined area. The CPU 101 determines that the cursor 308 is within the predetermined area if the position of the cursor 308 is within any of the upper edge portion 511, right edge portion 512, left edge portion 513 and lower edge portion 514, and otherwise (i.e. the cursor 308 is within the central portion 515) determines that the cursor 308 is not within the predetermined area.

If it is determined that the cursor 308 is not within the predetermined area (Step S1203; NO), the processing proceeds to the aftermentioned Step S1207. If it is determined that the cursor 308 is within the predetermined area (Step S1203; YES), the CPU 101 calculates the moving direction of the position of the viewpoint 305 and its moving distance per unit time. Alternatively, the CPU 101 calculates the rotation direction of the direction of the sight line 306 and its rotation angle per unit time (Step S1204).

Then, the CPU 101 corrects the moving distance of the position of the viewpoint 305 calculated in Step S1204 so that the smaller the distance “L1” becomes, the smaller the corrected moving distance ΔL becomes. Alternatively, the CPU 101 corrects the rotation angle of the direction of the sight line 306 calculated in Step S1204 so that the smaller the distance “L1” becomes, the smaller the corrected rotation angle ΔD becomes (Step S1205).

For example, in FIG. 9A, the CPU 101 selects the object (the object 902A in FIG. 9A) placed within the attention area 960 of the screen 501 from among the objects 901, 902A, 902B and 902C displayed on the screen 501. Next, the CPU 101 calculates the distance “L1” between the position of the selected object 902A and the position of the viewpoint 305. Then, the CPU 101 corrects the moving distance ΔL (or rotation angle ΔD) so that the smaller the calculated distance “L1” becomes, the smaller the corrected moving distance ΔL (or rotation angle ΔD) becomes.

Then, the CPU 101 moves the position of the viewpoint 305 in the moving direction calculated in Step S1204 by the moving distance ΔL corrected in Step S1205, per unit time. Alternatively, the CPU 101 moves the direction of the sight line 306 in the rotation direction calculated in Step S1204 by the rotation angle ΔD corrected in Step S1205, per unit time (Step S1206).

The CPU 101 stores the new moved position of the viewpoint 305 in the viewpoint information 852. Alternatively, the CPU 101 stores the new moved direction of the sight line 306 in the sight line information 853.

The CPU 101 generates an image by projecting the virtual space 301 to the projection plane 307 in the direction of the sight line 306 from the position of the viewpoint 305 (Step S1207).

According to the present embodiment, the CPU 101 makes the image processor 107 draw a predetermined image representing the cursor 308 at the position of the cursor 308 stored in the cursor information 854. However, the cursor information 854 is stored in the RAM 103, but the image representing the cursor 308 may be not drawn.

Then, the CPU 101 makes the image processor 107 display the image generated in Step S1207 on the monitor (Step S1208).

Generally, in the state where the player is gazing at a particular portion within the screen 501, if the screen 501 widely scrolls, it is possible that the image becomes difficult to be seen by the player or the player becomes dizzy.

For example, it is presumed that the player tends to pay more attention to around the center of the screen 501. Meanwhile, it is also presumed that the object closer to the viewpoint 305 attracts more attention from the player.

Therefore, according to the present embodiment, if the object 303 is drawn around the center of the screen 501 and is placed adjacent to the viewpoint 305, the CPU 101 presumes that the player is gazing around the center of the screen 501 and reduces the scroll amount.

Consequently, the present embodiment prevents the state where the scroll speed of the screen 501 is so fast that the image becomes difficult to be seen on the whole, thereby improving the visibility of the screen 501 for the player. For example, it prevents frequent scrolls of the screen, thereby preventing the player from becoming dizzy. It also prevents frequent occurrences of scroll processing due to the move of the viewpoint 305, thereby reducing the burden of scroll processing on the game device 800.

According to the present embodiment, all of the upper edge portion 511, right edge portion 512, left edge portion 513 and lower edge portion 514 are used as the predetermined area, but one of these or a combination of two or more of these may be used as the predetermined area. For example, in a game in which the screen 501 scrolls only in the upward and downward direction (vertical direction) for the player, only two of the upper edge portion 511 and lower edge portion 514 may be used as the predetermined area. Alternatively, for example, in a game in which the screen 501 scrolls only in the leftward and rightward direction (horizontal direction) for the player, only two of the right edge portion 512 and left edge portion 513 may be used as the predetermined area.

According to the present embodiment, the predetermined area and attention area 960 are separately defined, but the central portion 515 of the predetermined area may be used as the attention area 960.

The shape of the predetermined area is not limited to a rectangle, but may be any shape such as a circle, an oval and a polygon.

According to the present embodiment, a certain area around the center of the screen 501 is set to be the attention area 960, but the entire screen 501 may be set to be the attention area 960. For example, if only one object 303 exists within the screen 501, it is presumed that a portion where the object 303 is displayed in the screen 501 attracts more attention from the player. Therefore, by reducing the scroll amount, the visibility of the screen 501 can be improved.

Since the CPU 101 calculates the change amounts of the direction and distance per unit time, it changes the scroll speed by scrolling the screen fast or slowly. However, the absolute scroll amount may be increased or decreased instead of the scroll speed. In other words, the CPU 101 may calculate the “total” moving direction and moving distance (or the rotation direction and rotation angle) that has been finally scrolled, instead of the moving direction and moving distance (or the rotation direction and rotation angle) “per unit time”. In this case, in the aforementioned description, the moving direction and moving distance (or the rotation direction and rotation angle) “per unit time” may be replaced by the “total” moving direction and the “total” moving distance (or the rotation direction and rotation angle).

### Second Embodiment

Next, another embodiment of the present invention will be described. In the aforementioned embodiment, the scroll amount is corrected by using the position of the object 303 placed within the attention area 960 of the screen 501 in the virtual space 301. However, there are cases in which a plurality of objects 303 exists within the attention area 960. According to the present embodiment, it is assumed that a plurality of objects 303 is drawn within the attention area 960 of the screen 501.

A short distance between the viewpoint 305 and object 303 means that a projection image of the object 303 to the projection plane 307 is more largely drawn. In other words, the larger the object 303 drawn on the screen 501 becomes, the closer to the viewpoint 305 the object 303 tends to become. In the aforementioned embodiment, it is assumed that the object 303 closer to the viewpoint 305 attracts more attention. However, it is presumed that the player often determines which of the position the object 303 exits, e.g., adjacent to the viewpoint 305 or far from the viewpoint 305 and what portion of the screen 501 to gaze, based on not only the object 303 but also the state surrounding the object 303 (for example, what other object exists near the object 303). Therefore, according to the present embodiment, if the plurality of objects 303 are drawn on the screen 501, the front and back relationship (depth) of these objects viewed from the viewpoint 305 is taken into consideration.

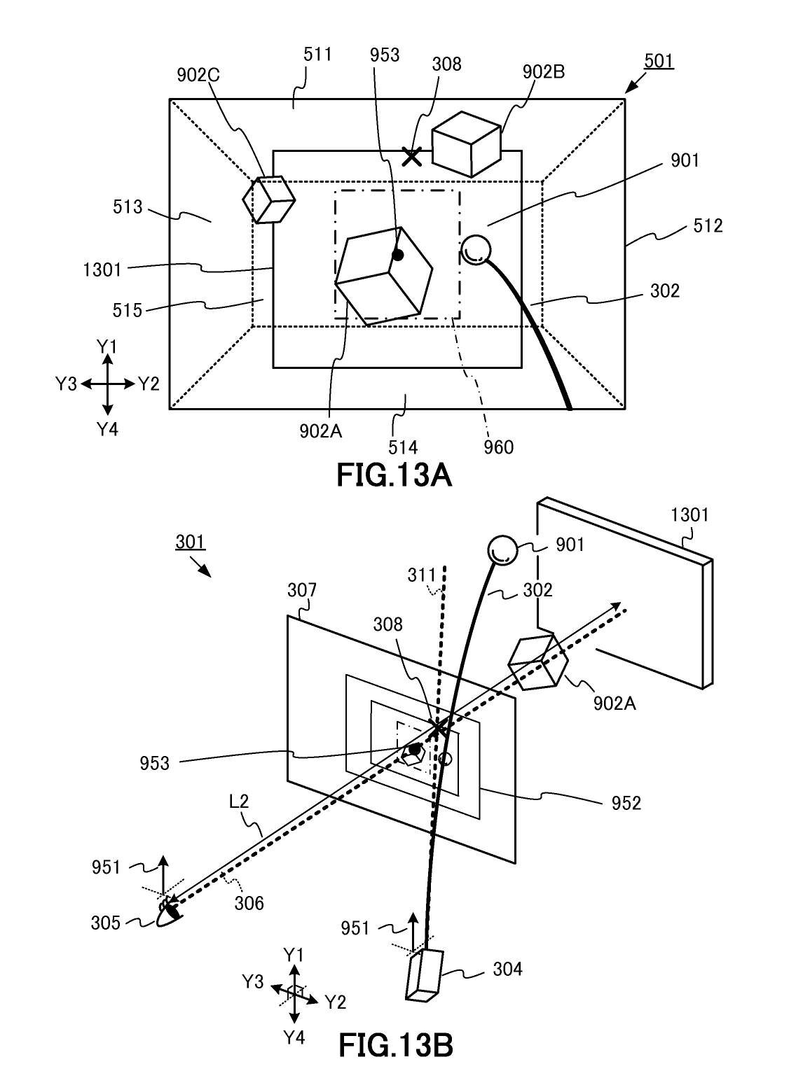

FIG. 13A is an example of the screen 501 displayed on the monitor. The screen 501 displays, as the objects 303, the object 901 gripped by the reacher 302, the objects 902A, 902B and 902C, as well as an object 1301 placed as a background of the object 902A. FIG. 13B is a diagram illustrating the virtual space 301, in which the screen 501 illustrated in FIG. 13A is displayed.

Here, “an object (OBJ1) is placed as a background of another object (OBJ2)” means that when assuming that a straight line (one-dimensional) coordinate system is defined with the direction of the sight line 306 being the positive direction, a OBJ1 coordinate value is greater than a coordinate value of OBJ2 and a screen area where OBJ1 is drawn overlaps a screen area where OBJ2 is drawn. The object OBJ1 will be referred to as “a background object”. If a plurality of objects is placed in the background of the object OBJ2, the object placed closest to the object OBJ2 is set to the background object.

If a plurality of objects 303 exist in the virtual space 301 and the position of the viewpoint 305 or the direction of the sight line 306 is variable, all of the objects 303 can be a background object.

In the aforementioned Step S1204, the CPU 101 selects a background object of the object drawn closest to the center of the attention area 960 from among the objects 901, 902A, 902B, 902C and 1301 displayed on the screen 501 (object 902A in this case). That is, in FIG. 13A, the CPU 101 selects the object 1301 as a background object. Then, the CPU 101 calculates the moving direction and moving distance of the position of the viewpoint 305.

That is, in the aforementioned Step S1205, the CPU 101 calculates a distance “L2” between the position of the selected object 1301 and the position of the viewpoint 305. Then, the CPU 101 corrects the moving distance ΔL so that the smaller the calculated distance “L2” becomes, the smaller the moving distance ΔL becomes.

For example, the CPU 101 may use a function obtained by replacing the distance “L1” with the distance “L2” in any of functions illustrated in FIGS. 10A to 10D and may use a combination of these functions. A function can be freely set as long as the function fulfills the relationship in which the smaller the distance “L2” becomes, the smaller the moving distance ΔL becomes.

Also in the present embodiment, the direction of the sight line 306 may be moved, instead of moving the position of the viewpoint 305. Both of the position of the viewpoint 305 and the direction of the sight line 306 may be changed. If the direction of the sight line 306 is changed, the CPU 101 may use a function obtained by replacing the distance “L1” with the distance “L2” as well as by replacing the moving distance ΔL with the rotation angle ΔD in any of the functions illustrated in FIGS. 10A to 10D, or may use a combination of these functions. A function can be freely set as long as the function fulfills the relationship in which the smaller the distance “L2” becomes, the smaller the rotation angle ΔD becomes.

Furthermore, the CPU 101 changes the position of the viewpoint 305 in the calculated moving direction by the corrected moving distance ΔL (Step S1206) and stores the new position of the viewpoint 305 in the viewpoint information 852. Alternatively, the CPU 101 changes the direction of the sight line 306 in the calculated rotation direction by the corrected rotation angle ΔD and stores the new direction of the sight line 306 in the sight line information 853. Then, the CPU 101 generates an image by projecting the virtual space 301 to the projection plane 307 in the direction of the sight line 306 from the position of the viewpoint 305 (Step S1207) and displays the generated image on the monitor (Step S1208).

As described above, in the state where the player is gazing at a certain portion within the screen 501, if the screen 501 widely scrolls, it is possible that the image becomes difficult to be seen for the player.

For example, when n (n≧2) pieces of objects (OBJ1, OBJ2, . . . , OBJn) are drawn on the screen 501 and if a plurality of objects (for example, two objects, OBJ1 and OBJ2) drawn around the center of the screen 501 among these objects is placed closer to the viewpoint 305 compared to other objects, it is presumed that the player pays more attention to around the center of the screen 501 than other area.

However, if, one (OBJ1) of the objects drawn around the center of the screen 501 is placed adjacent to the viewpoint 305 and the other (OBJ2) is placed far from the viewpoint 305, it cannot be always said that the player pays more attention to around the center of the screen 501 than other area because it cannot be easily presumed whether or not the player are gazing at OBJ1 and OBJ2.

Therefore, in the present embodiment, by paying attention to an object placed as a background (background object) of the objects (OBJ1, OBJ2) drawn around the center of the screen 501 that is generally presumed to attract more attention from the player, the closer to the viewpoint 305 the background object becomes, the less the scroll amount becomes. That is, when the background object is close to the viewpoint 305, the other object is further close to the viewpoint 305. Therefore, it is presumed that an area around the center of the screen 501 where OBJ1 and OBJ2 are placed attracts more attention from the player, thereby reducing the scroll amount.

Therefore, the present embodiment prevents the state where the scroll speed of the screen 501 is so fast that the image becomes difficult to be seen on the whole, thereby improving the visibility of the screen 501 for the player. For example, it prevents frequent scrolls of the screen, thereby preventing the player from becoming dizzy. It also prevents frequent occurrences of scroll processing due to the move of the viewpoint 305, thereby reducing the burden of scroll processing on the game device 200.

### Third Embodiment

Next, another embodiment of the present invention will be described. Also in the present embodiment, it is assumed that a plurality of objects 303 is drawn within the attention area 960 of the screen 501.

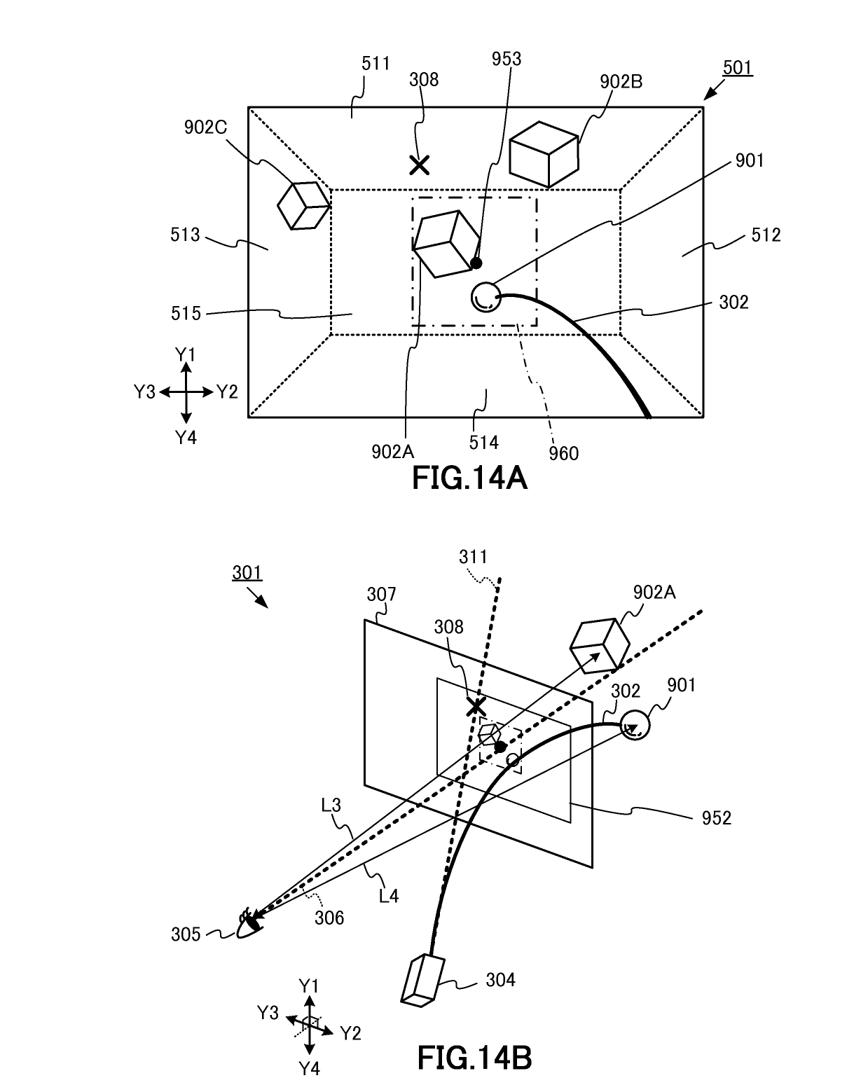

FIG. 14A is an example of the screen 501 displayed on the monitor.

FIG. 14B is a diagram illustrating the virtual space 301, in which the screen 501 illustrated in FIG. 14A is displayed.

According to the present embodiment, when a plurality of objects 303 is included within the attention area 960, the CPU 101 calculates distances between the viewpoint 305 and the respective objects 303 included in the attention area 960, regardless of whether or not they are background objects, and then corrects the moving distance of the position of the viewpoint 305 (or the rotation angle of the direction of the sight line 306).

The CPU 101 calculates distances between the position of the viewpoint 305 and the positions of the respective objects 303 placed within the attention area 960 of the screen 501, and calculate the average value of the respective distances.

For example, in FIG. 14A, the CPU 101 selects the objects (two objects, 901 and 902A, in FIG. 14A) placed within the attention area 960 of the screen 501 from among the objects 901, 902A, 902B and 902C displayed on the screen 501. Next, the CPU 101 calculates a distance “L3” between the position of the selected object 901 and the position of the viewpoint 305 and a distance “L4” between the position of the selected object 902A and the position of the viewpoint 305.

Then, the CPU 101 corrects the moving distance ΔL (or the rotation angle ΔD) so that the smaller the calculated average value becomes, the smaller the corrected moving distance ΔL (or the rotation angle ΔD) becomes. That is, the shorter the average distance between the viewpoint 305 and the object 303 included within the attention area 960 becomes, the less the scroll amount becomes.

Alternatively, the CPU 101 may calculate distances between the position of the viewpoint 305 and the positions of the respective objects 303 placed within the attention area 960 of the screen 501 and correct the moving distance ΔL (or rotation angle ΔD) so that the smaller the maximum value of the respective values becomes, the smaller the corrected moving distance ΔL (or rotation angle ΔD) becomes. That is, the shorter the distance between the viewpoint 305 and the object 303 farthest from the viewpoint 305 of the objects 303 included within the attention area 960 becomes, the less the scroll amount may become.

Alternatively, the CPU 101 may calculate distances between the position of the viewpoint 305 and the positions of the respective objects 303 placed within the attention area 960 of the screen 501 and correct the moving distance ΔL (or rotation angle ΔD) so that the smaller the minimum value of the respective values becomes, the smaller the corrected moving distance ΔL (or rotation angle ΔD) becomes. That is, the smaller the distance between the viewpoint 305 and the object 303 closest to the viewpoint 305 of the objects 303 included within the attention area 960 becomes, the less the scroll amount may become.

Alternatively, the CPU 101 may calculate distances between the position of the viewpoint 305 and the positions of the respective objects 303 placed within the attention area 960 of the screen 501 and correct the moving distance ΔL (or rotation angle ΔD) so that the smaller the total value of the respective values becomes, the smaller the corrected moving distance ΔL (or rotation angle ΔD) becomes. That is, in the case where the objects 303 are close to the viewpoint 305 or the number of objects is great even if there are some objects 303 far from the viewpoint 305, there is no need to reduce the scroll amount.

According to the present embodiment, the scroll amount changes depending on how close (far) the respective objects 303 included within the attention area 960 are to (from) the viewpoint 305. If the respective objects 303 included within the attention area 960 tend to be closer to the viewpoint 305 on the whole, the scroll amount is reduced. If they tend to be far from the viewpoint 305 on the whole, the scroll amount is increased. Therefore, the present embodiment can prevent the state where the scroll speed of the screen 501 is so fast that the image becomes difficult to be seen on the whole, thereby improving the visibility of the screen 501 for the player. For example, it prevents frequent scrolls of the screen, thereby preventing the player from becoming dizzy. It also prevents frequent occurrences of scroll processing due to the move of the viewpoint 305, thereby reducing the burden of scroll processing on the game device 800.

### Fourth Embodiment

Next, another embodiment of the present invention will be described. In the aforementioned embodiments, the attention area 960 is fixed to the center of the screen 501 whereas in the present embodiment the position of the attention area 960 is variable.

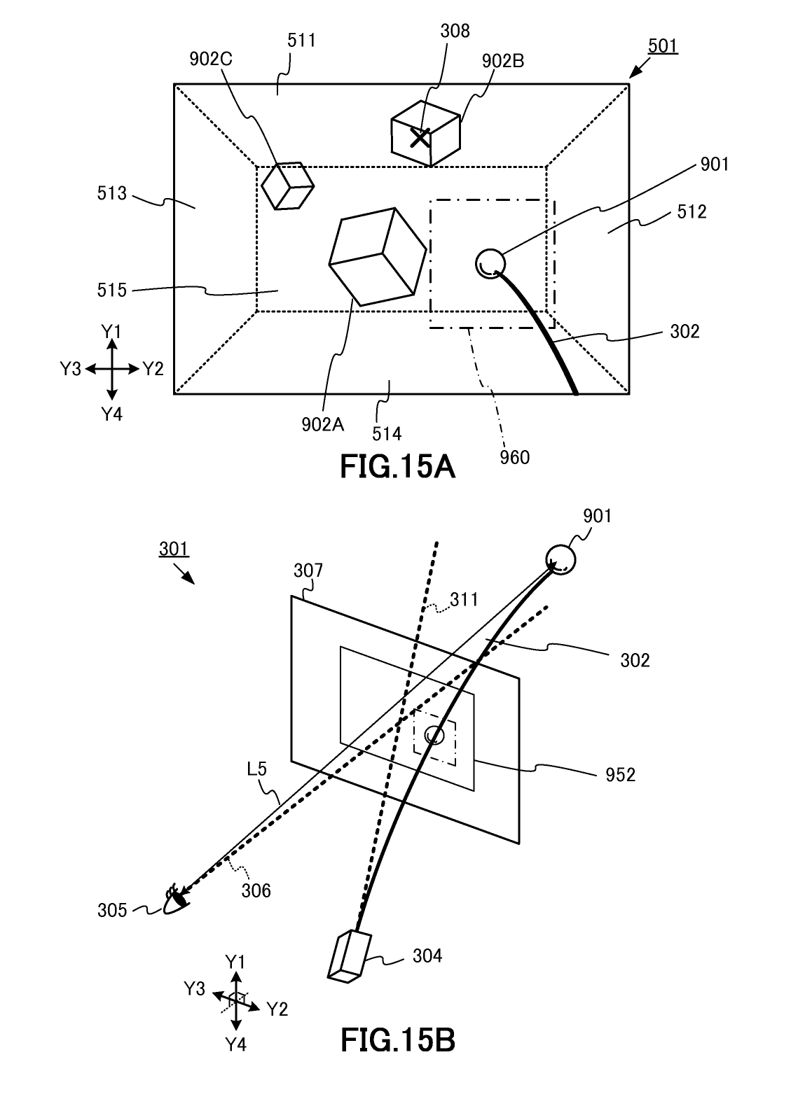

FIG. 15A is an example of the monitor screen 501 displayed on the monitor.

FIG. 15B is a diagram illustrating the virtual space 301, in which the screen 501 illustrated in FIG. 15A is displayed.

The distance calculation unit 805 sets the attention area 960 such that the object 303 selected by the player is centered at a position generated by the generation unit 803 in the screen 501 and calculates a distance “L5” between the position of the viewpoint 305 and the position of the object 303 included in the attention area 960.

More specifically, the CPU 101 selects the object 303 selected by the player from among the objects 303 placed in the virtual space 301. Here, “the object 303 selected by the player” is the object 303 gripped by the reacher 302, for example. In FIG. 15A, the object 901 is selected.

Then, the CPU 101 calculates a distance “L5” between the position of the viewpoint 305 in the virtual space 301 and the position of the selected object 303 in the virtual space 301. If a plurality of objects 303 exists in the attention area 960 set by the CPU 101, the CPU 101 corrects the moving distance ΔL (or rotation angle ΔD) so as to monotonically decrease relative to the average value, maximum value or minimum value of the respective distances between the position of the viewpoint 305 and the respective objects 303.

The player can freely change the position of the object 303 gripped by the reacher 302 or the position of the cursor 308 by changing the position and posture of the grip module 201. In other words, the position of the object 303 selected by the player is variable.

When receiving a move instruction input to move the position of the object 303 selected by the player from the player, the CPU 101 moves the position of the object 303 in the moving direction by the moving distance specified by the move instruction input and updates the object information 851.

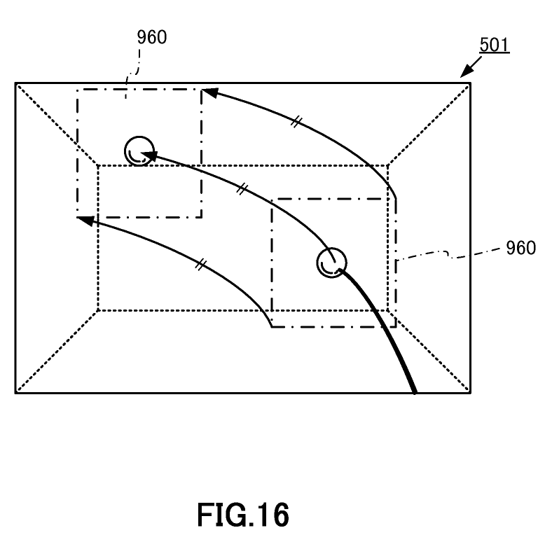

When the CPU 101 moves the position of the object 303 selected by the player, it also moves the position of the attention area 960, as illustrated in FIG. 16. For example, the CPU 101 moves the position of the object 303 and immediately moves the position of the attention area 960. That is, the position of the attention area 960 moves with being fixed to the position of the object 303 selected by the player.

Alternatively the CPU 101 moves the position of the object 303 selected by the player, and may move the position of the attention area 960 so as to follow the object 303 in a predetermined time period after the object 303 has started to move. In this case, the CPU 101 temporarily stores a moving history of the position of the object 303 during a predetermined time period “T1” in the RAM 103 and so on. The moving history is a history of the position of the object 303 during a predetermined past time period up to the current time.

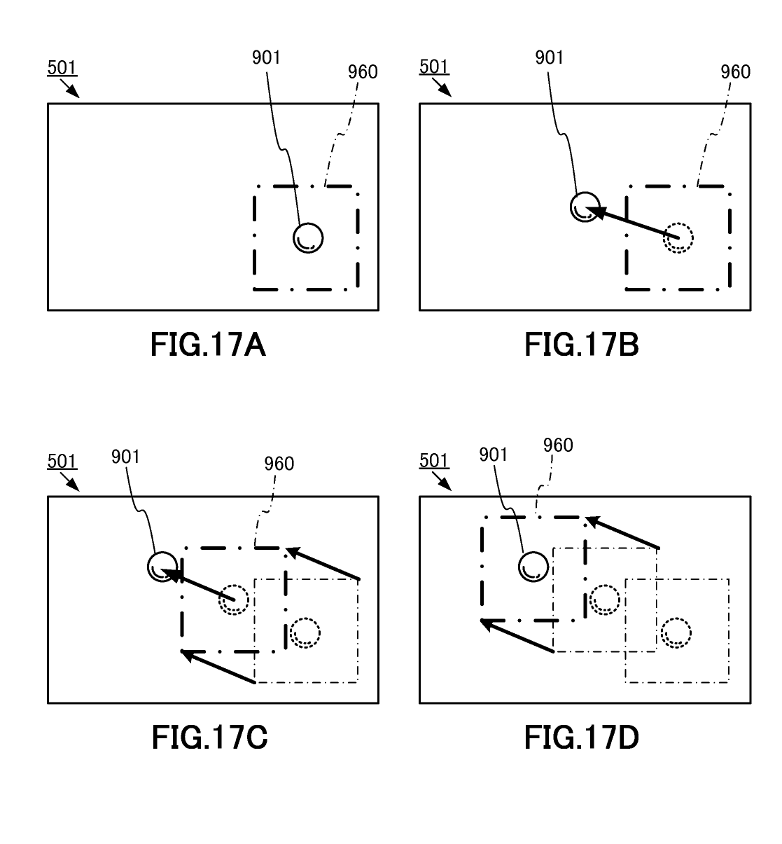

For example, FIG. 17A is a diagram illustrating the screen 501 before the object 303 starts to move. The CPU 101 starts to move the object 901 selected by the player.

After starting to move, the CPU 101 does not move the attention area 960 as illustrated in FIG. 17B until a predetermined time period “T2” (where T2≦T1, typically T2=T1) has passed. The CPU 101 temporarily stores the position of the object 303 as the moving history in the RAM 103 and so on.

After the predetermined time period “T2” has passed, the CPU 101 moves the attention area 960 so as to follow the moving trajectory of the object 901, as illustrated in FIG. 17C with a delay of the predetermined period time “T2”.

Finally, as illustrated in FIG. 17D, the attention area 960 reaches the position where the object 901 has finished its move. In this way, the CPU 101 may move the attention area according to the moving history of the object 303.

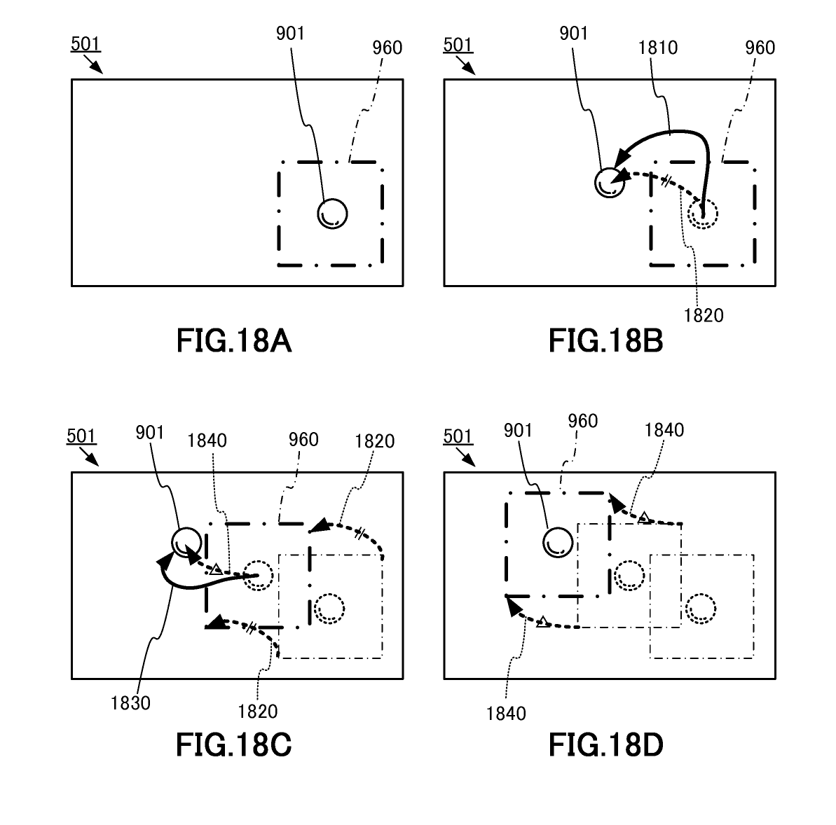

Alternatively, the CPU 101 may obtain a moving route of the attention area 960 by performing some operation on the moving history of the object 303. For example, FIG. 18A is a diagram illustrating the screen 501 before the object 303 starts to move. The CPU 101 starts to move the object 901 selected by the player. After the start of moving of the object 901, the CPU 101 does not move the attention area 960 until the predetermined period time “T2” (where T2≦T1, typically, T2=T1) has passed, as illustrated in FIG. 18B. After the predetermined period time “T2” has passed, the CPU 101 refers to the moving history of the object 901 and performs filtering lest the displacement of the position per unit time exceeds a predetermined threshold, thereby obtaining the moving route of the attention area 960.

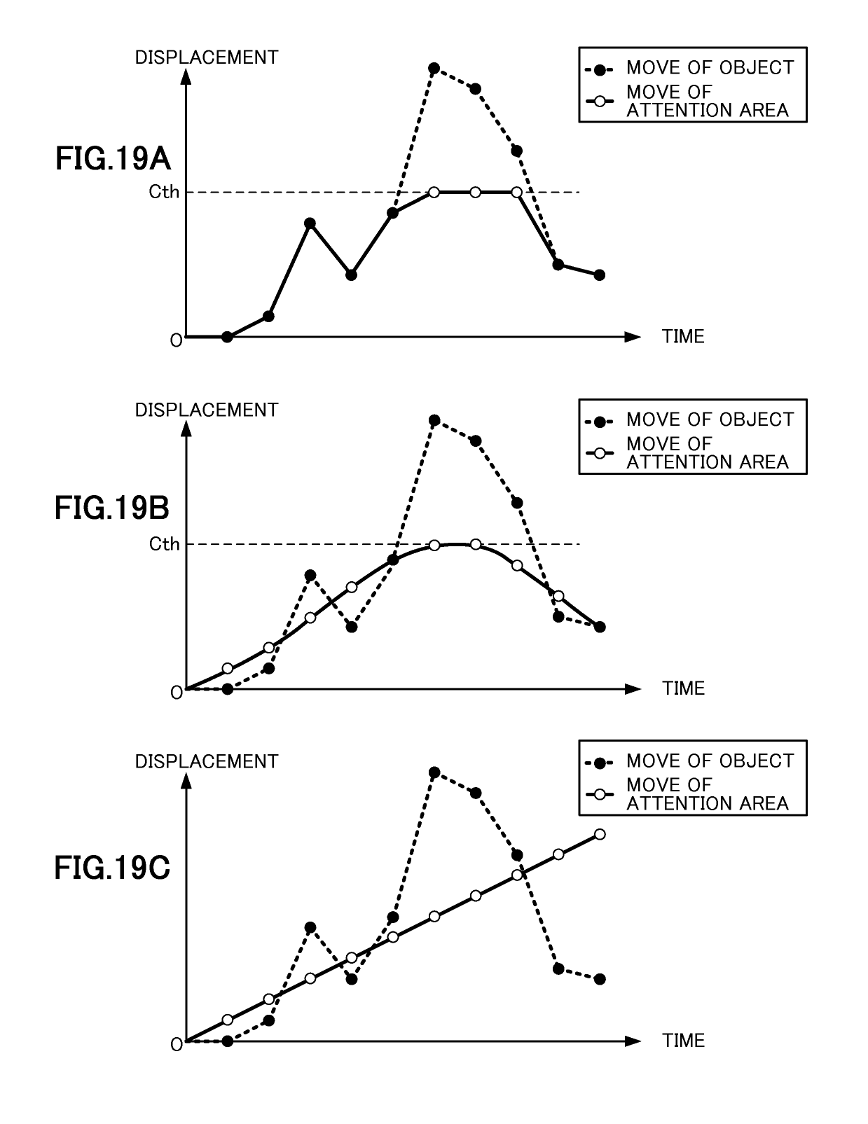

FIGS. 19A and 19B are diagrams illustrating the moving route (trajectory) of the object 303 and the moving route (trajectory) of the attention area 960.

In FIG. 19A, in a portion where the displacement (for example, displacement of X-axis direction component and Y-axis direction component) of the position of the object 303 is greater than the threshold value “Cth”, the displacement of the position of the attention area 960 is reduced to the threshold value. That is, the trajectory of the attention area 960 can be obtained by subjecting the trajectory of the object 303 to low pass filtering in which its maximum value is “Cth”. It also can be said that the trajectory of the attention area 960 is a trajectory by removing a high-frequency component from the trajectory of the object 303. Even if the position of the object 303 largely moves instantaneously, the trajectory has less effect on the attention area 960.

In FIG. 19B, in a portion where the displacement of the position of the object 303 is greater than the threshold value “Cth”, the displacement of the position of the attention area 960 is reduced to the threshold value and an approximate curve that approximately passes respective points is set to the trajectory of the attention area 960. As this approximation, a well-known approximate method such as a spline approximation and a least squares approximation can be employed. The trajectory of the attention area 960 becomes a shape of smoothing the trajectory of the object 303.

In FIG. 19C, the CPU 101 sets the average value of the displacement values at the respective points of the trajectory of the object 303 to the displacement value of the trajectory of the attention area 960. The trajectory of the attention area 960 becomes a linear shape.

The CPU 101 may obtain the moving route of the attention area 960 by any of the methods illustrated in FIGS. 19A to 19C or by combining these methods.

Returning to FIG. 18B, the CPU 101 obtains a moving route 1820 of the attention area 960 from a moving route 1810 of the object 303. Then, the CPU 101 moves the attention area 960 along the obtained moving route as illustrated in FIG. 18C. During move of the attention area 960, the object 303 is moving further along a moving route 1830. Therefore, the CPU 101 obtains a moving route 1840 of the attention area 960 in the similar manner as above, and moves the attention area 960. Then, as illustrated in FIG. 18D, the attention area 960 finally reaches the position where the object 901 has finished its move.

According to the present embodiment, since the position of the attention area 960 is changed by the player's operating the grip module 201, an area that attracts much attention from the player within the screen 501 can be more accurately presumed, thereby reducing the scroll amount. Therefore, the present embodiment can prevent the state where the scroll speed of the screen 501 is so fast that the image becomes difficult to be seen on the whole, thereby further improving the visibility of the screen 501 for the player. Furthermore, it prevents frequent occurrences of scroll processing, thereby reducing the burden of scroll processing on the game device 800.

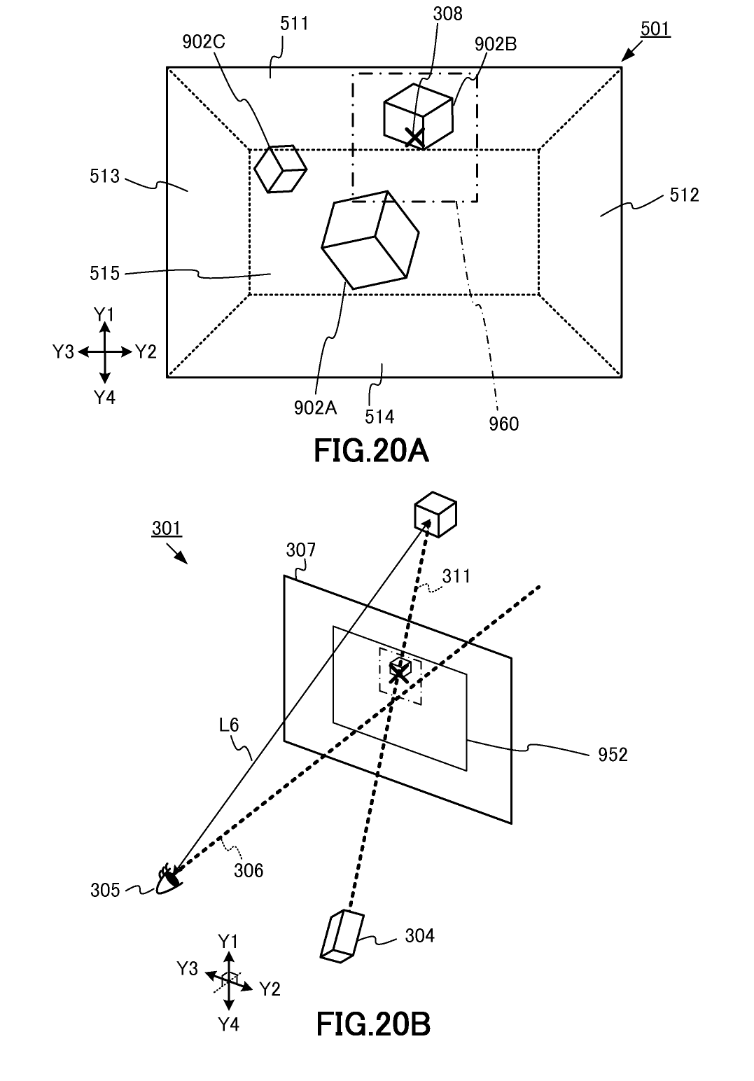

The CPU 101 may select the object 303 placed at the position of the cursor 308 as the object 303 selected by the player, as illustrated in FIGS. 20A and 20B. For example, if the reacher 302 is not gripping any objects 303, the object that is placed at the position of the cursor 308 may be dealt with as a selected object. Then, the CPU 101 may calculate a distance “L6” between the position of the viewpoint 305 in the virtual space 301 and the position of the object 303 placed at the position of the cursor 308 in the virtual space 301, and correct the moving distance ΔL (or rotation angle ΔD) so as to monotonically decrease relative to the calculated distance.

The selection of the object 303 by the player is not limited to gripping by the reacher 302. The CPU 101 can receive a selection instruction input to select any one or more objects 303 from the user and set the object 303 indicated by the selection instruction input to the object 303 selected by the player.

### Fifth Embodiment

Next, another embodiment of the present invention will be described. The present invention can be applied to not only the game performed in the three-dimensional virtual space as described above but also a game performed in a two-dimensional virtual space. Details will be described below.

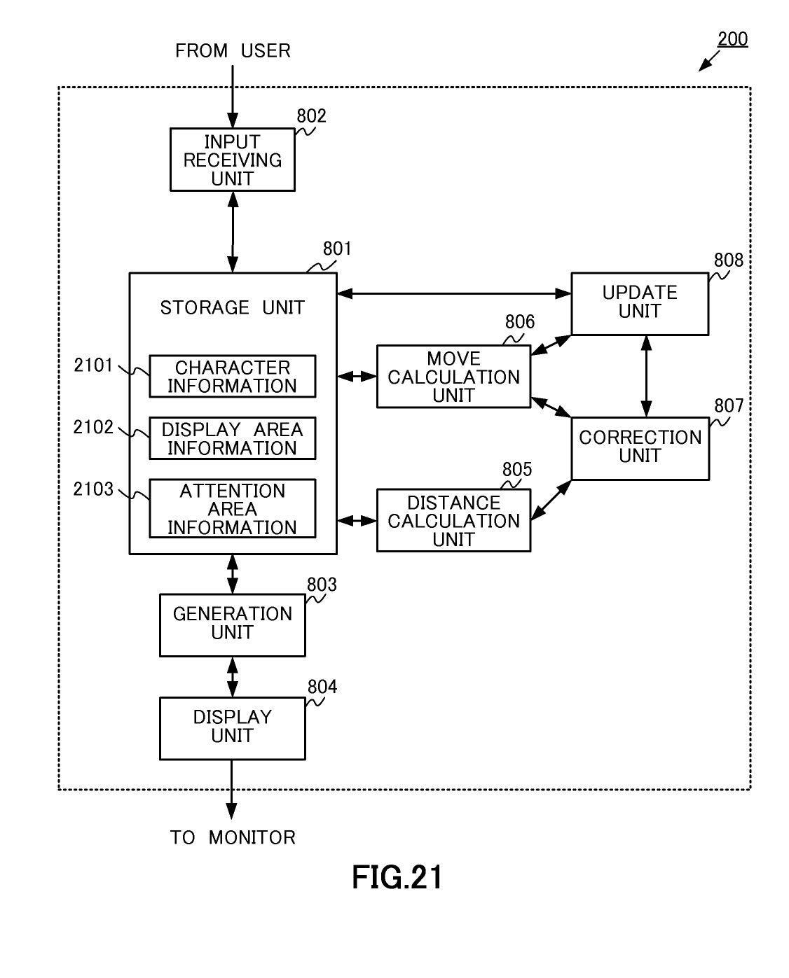

FIG. 21 is a diagram illustrating a functional configuration of the game device 200 according to the present embodiment.

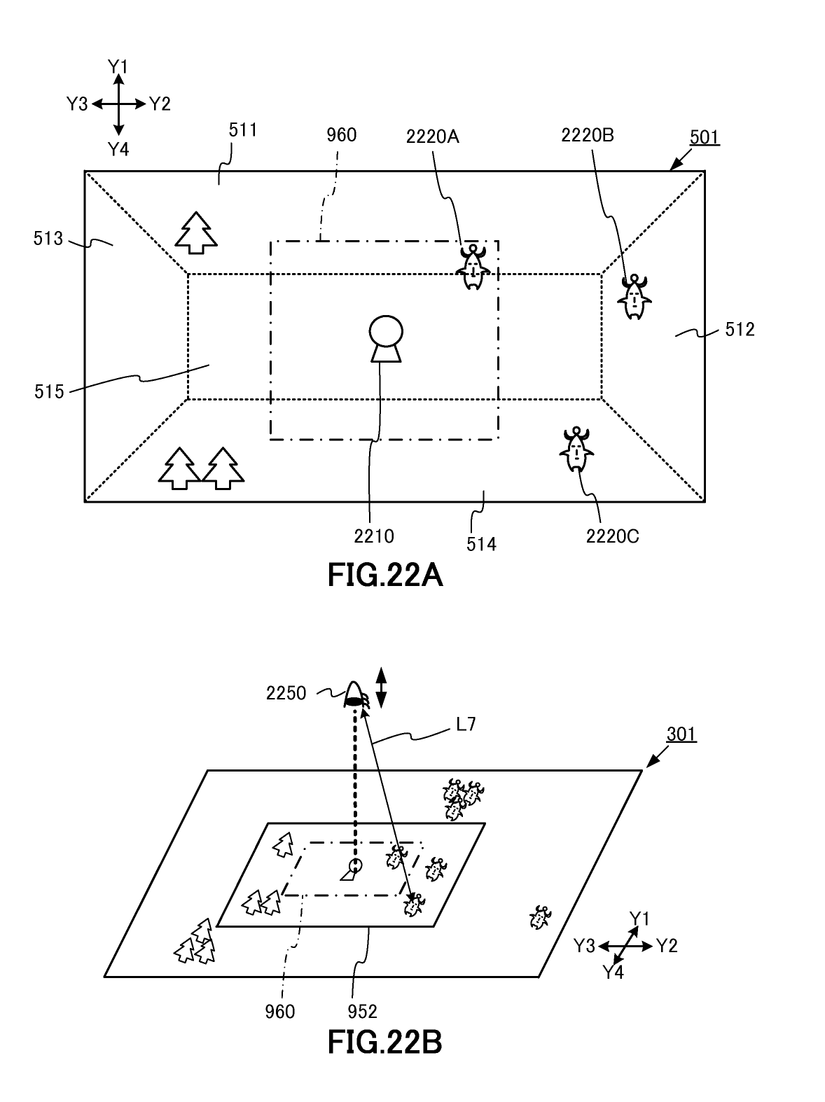

FIG. 22A is an example of the screen 501 displayed on the monitor. According to the present embodiment, since a two-dimensional virtual space is assumed, the object 303 is “a planar object” (image data). In the present embodiment, it is referred to as “a character”, instead of “an object”. In the screen 501, an image included within the display area 952 in the virtual space 301 is displayed on the monitor.

FIG. 22B is a diagram illustrating the virtual space 301, in which the screen 501 illustrated in FIG. 22A is displayed. In the virtual space 301, a character such as a player character 2210 and other characters 2220 are placed.

According to the present embodiment, in the screen 501, an image included in the display area 952 is displayed on the monitor. Unlike the aforementioned embodiments, one viewpoint 305 and one sight line 306 do not exist in the virtual space 301. However, description will be made using a “pseudo” viewpoint 2250 for easy understanding of the concept of the aftermentioned enlargement and reduction (zooming in and zooming out) of the screen 501.

An intersection point of the display area 952 and a vertical line from the pseudo viewpoint 2250 to the display area 952 always corresponds to the center point (gravity point) of the display area 952.

In the game used in the present embodiment, part of the two-dimensional virtual space can be zoomed in (enlarged) and displayed or the whole two-dimensional virtual space can be zoomed out (reduced) and displayed. Zooming-in corresponds to moving the pseudo viewpoint 2250 closer to the display area 952 and zooming-out corresponds to moving the pseudo viewpoint 2250 away from the display area 952.

The storage unit 801 stores a character information 2101 indicating a position of the character, a display area information 2102 indicating the position and the size of the display area 952, and an attention area information 2103 indicating the position of the attention area 960. The CPU 101 and RAM 103 work together to function as the storage unit 801.

The input receiving unit 802 receives various instruction inputs from the user that is operating the grip module 201 (or game pad or touch panel). For example, the input receiving unit 802 receives a move instruction input to move the position of the viewpoint 305 and a selection instruction input to select an arbitrary object 303 as an object to be operated from the player. The CPU 101, RAM 103 and controller 105 work together to function as the input receiving unit 802.

The attention area 960 is set to, for example, the position of the center of the display area 952. However, the CPU 101 may move the attention area 960 to the position where the position of the character indicated by the selection instruction input is centered, as the aforementioned embodiment.

The generation unit 803 generates an image of the character and so on included in the display area 952. In other words, the generation unit 803 generates an image representing the character and so on, in the virtual space 301, viewed from the position of the pseudo viewpoint 2250. The CPU 101, RAM 103 and image processor 107 work together to function as the generation unit 803.

The display unit 804 displays an image generated by the generation unit 803 on the monitor. The CPU 101, RAM 103 and image processor 107 work together to function as the display unit 804.

The distance calculation unit 805 obtains a distance “L7” between the position of the pseudo viewpoint 2250 and the position of the character drawn within the attention area 960 of the image generated by the generation unit 803. The CPU 101, RAM 103 and image processor 107 work together to function as the distance calculation unit 805.

If a plurality of characters exists in the attention area 960, the distance calculation unit 805 may obtain distances “L7” between the pseudo viewpoint 2250 and the respective characters and further obtain their average value, maximum value, minimum value and total value.

The move calculation unit 806 calculates the moving direction and moving distance of the display area 952. In other words, the move calculation unit 806 calculates the moving direction and moving distance of the pseudo viewpoint 2250. The CPU 101 and RAM 103 work together to function as the move calculation unit 806.

The correction unit 807 corrects the moving distance calculated by the move calculation unit 806, based on the distance “L7” obtained by the distance calculation unit 805. At this time, the correction unit 807 corrects the moving distance so that the corrected moving distance monotonically decreases relative to the distance “L7”. The CPU 101 and RAM 103 work together to function as the correction unit 807.

The update unit 808 updates the display area information 2102 so as to move the position of the display area 952 in the moving direction calculated by the move calculation unit 806 by the moving distance corrected by the correction unit 807. The CPU 101 and RAM 103 work together to function as the update unit 808.

Next, image display processing according to the present embodiment will be described, taking the case where the screen 501 is zoomed out as an example. In the present embodiment, the game device 200 can freely change a display magnification of the screen 501 according to an instruction input from the user.

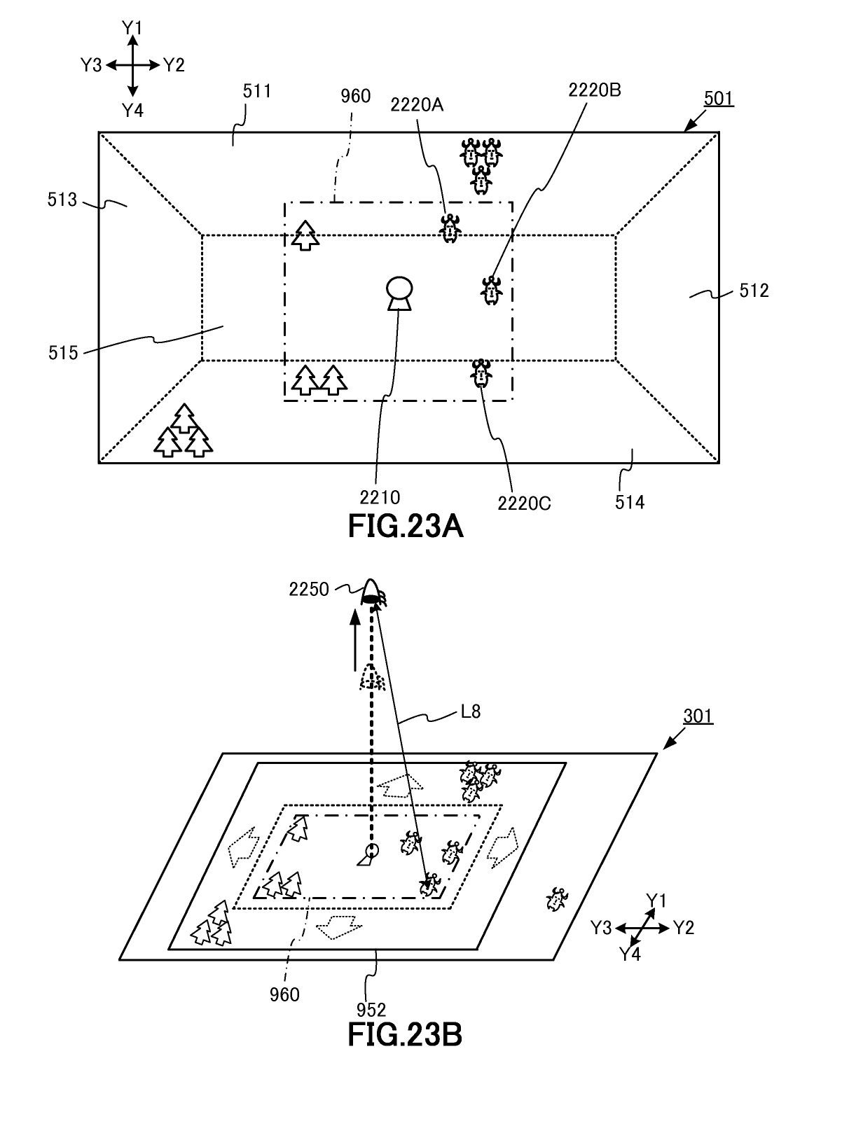

FIG. 23A is an example of the screen 501, in which the screen 501 illustrated in FIG. 22A is zoomed out and a wider range of the virtual space 301 is displayed on the monitor.

FIG. 23B is a diagram illustrating the virtual space 301, in which the screen 501 illustrated in FIG. 23A is displayed.

When the CPU 101 receives an input instruction to change the display magnification of the screen 501 from the user, it enlarges or reduces the size of the display area 952. In the similar way, the size of the attention area 960 is also enlarged or reduced.

Explaining this enlargement or reduction by using the pseudo viewpoint 2250, they corresponds to the case that the CPU 101 changes a distance between the pseudo viewpoint 2250 and the virtual space 301 (height of the pseudo viewpoint 2250) with a view angle being constant. For example, if receiving an instruction input to zoom out the screen 501, the CPU 101 enlarges the display area 952 as illustrated in FIG. 23A. Therefore, although each character is drawn in a small size, a wider range of the virtual space is displayed on the monitor.

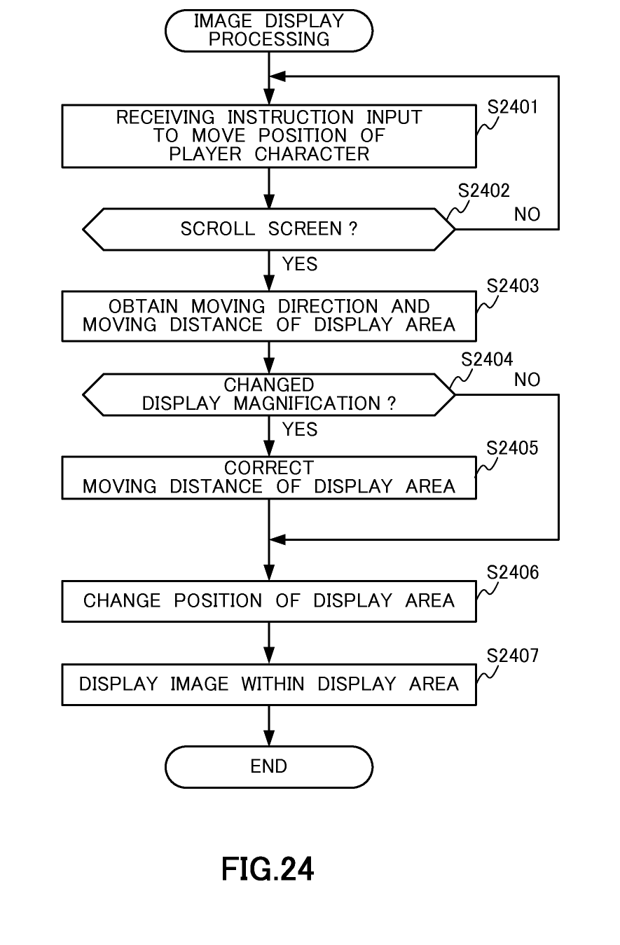

FIG. 24 is a flow chart illustrating image display processing according to the present embodiment.

First, the controller 105 (or a game pad or touch panel) receives an instruction input by each button to move the position of the player character 2210 to up, down, left or right input from the player (Step S2401). For example, when the controller 105 receives an instruction input to move the position of the player character 2210, the CPU moves the position of the player character 2210 to the specified direction. In moving the position of the player character 2210, the CPU 101 sets the player character 2210 to be always in the central portion 515.

The CPU 101 determines whether or not the screen 501 scrolls (Step S2402).

For example, the CPU 101 moves the position of the player character 2210 according to the instruction input if the position of the player character 2210 does not reach any of four sides of a rectangle defining the central portion 515. In this case, the CPU 101 determines that the screen 501 does not scroll.

If the position of the player character 2210 reaches any of four sides of a rectangle defining the central portion 515, the CPU 101 determines that the screen 501 scrolls.

If it is determined that the screen 501 does not scroll (Step S2402; NO), the processing returns to Step S2401. If it is determined that the screen 501 scrolls (Step S2402; YES), the CPU 101 obtains the moving direction and moving distance per unit time of the display area 952 (Step S2403).

For example, if the position of the player character 2210 reaches any of four sides of the rectangle defining the central portion 515 and an instruction input to further move the position of the player character 2210 to outside of the central portion 515 is received, the CPU 101 sets the direction indicated by the instruction input to the moving direction of the display area 952 and sets a predetermined value to the moving distance of the display area 952.

The CPU 101 determines whether or not the display magnification of the screen 501 has been changed (Step S2404).

If the display magnification has not been changed (Step S2404; NO), the processing proceeds to Step S2406. If the display magnification has been changed (Step S2404; YES), the CPU 101 corrects the moving distance of the display area 952 obtained in Step S2403 (Step S2405).

Specifically, the CPU 101 corrects the moving distance of the display area 952 so that the smaller the distance “L7” between the pseudo viewpoint 2250 and the virtual space 301 becomes, the smaller the moving distance of the display area 952 becomes. That is, the corrected moving distance monotonically decreases relative to the distance “L7”.

The CPU 101 moves the display area 952 in the moving direction obtained in Step S2403 by the moving distance corrected in Step S2405 (Step S2406).

Then, the CPU 101 makes the image processor 107 display an image within the display area 952 on the monitor (Step S2407).

According to the present embodiment, if the display magnification of the screen 501 is not changed, the scroll amount is invariable. However, if the display magnification is changed, the closer to the center of the attention area 960 the position of the character becomes, the less the scroll amount becomes. Therefore, the present embodiment can prevent the state where the scroll speed of the screen 501 is so fast that the image becomes difficult to be seen on the whole, thereby improving the visibility of the screen 501 for the player. For example, it prevents frequent scrolls of the screen, thereby preventing the player from becoming dizzy. It also prevents frequent occurrences of scroll processing, thereby reducing the burden of scroll processing on the game device 200.

The present invention is not limited to the aforementioned embodiments, and various variations and applications are possible. Furthermore, each component of the aforementioned embodiments can be freely combined.

A program to make a computer operate as the whole or part of the game device 800 may be stored and distributed in a computer-readable recording medium such as a memory card, a CD-ROM, a DVD and a MO (Magneto Optical Disk) and may be installed to another computer and to make the computer operate as the aforementioned means or perform the aforementioned processes.

Furthermore, the program may be stored in a disc device and the like that a server device on the Internet has, superimposed on, for example, a carrier wave and downloaded to a computer.

This application claims the priority based on Japanese Patent Application No. 2008-081003 and all content of which is incorporated herein.

### INDUSTRIAL APPLICABILITY

As described above, the present invention can provide a game device, a game processing method and a program that are suitable for reducing the burden of scroll processing of an image display and improving the visibility of a screen for the player.

What is claimed is:

1. A game device comprising:
a storage unit which stores a position of an object placed in a virtual space and a viewpoint position placed in the virtual space;
a generation unit which generates an image representing the object viewed from the viewpoint in the virtual space;
a display unit which displays the generated image;
a distance calculation unit which obtains a distance between the position of the object in the virtual space and the stored viewpoint position;
a move calculation unit which calculates a moving direction and a moving distance of the move of the viewpoint position;
a correction unit which corrects the calculated moving distance based on the obtained distance; and
an update unit which updates the stored viewpoint position so as to move in the calculated moving direction by the corrected moving distance;
wherein the correction unit performs the correction so that the corrected moving distance monotonically decreases relative to the obtained distance.

2. A game device comprising:
a storage unit which stores a position of an object placed in a virtual space, a viewpoint position placed in the virtual space, and sight line direction placed in the virtual space;
a generation unit which generates an image representing the object viewed from the viewpoint in the sight line direction in the virtual space;
a display unit which displays the generated image;
a distance calculation unit which obtains a distance between the position of the object in the virtual space and the stored viewpoint position;
a move calculation unit which calculates a rotation direction and a rotation angle of the rotation of the sight line direction;
a correction unit which corrects the calculated rotation angle based on the obtained distance; and
an update unit which updates the stored sight line direction so as to rotate in the calculated rotation direction by the calculated rotation angle;
wherein the correction unit performs the correction so that the corrected rotation angle monotonically decreases relative to the obtained distance.

3. The game device according to claim 2,
wherein the move calculation unit further calculates a moving direction and a moving distance of the move of the viewpoint position;
wherein the correction unit further corrects the calculated moving distance based on the obtained distance;
wherein the update unit further performs updating so as to move the stored viewpoint position in the calculated moving direction by the corrected moving distance; and
wherein the correction unit performs the correction so that the corrected moving distance monotonically decreases relative to the obtained distance.

4. The game device according to claim 1,
wherein a plurality objects are placed in the virtual space,
wherein the storage unit stores a position of each of the plurality of objects, and
wherein the distance calculation unit obtains a distance between a position of an object drawn in an attention area of the generated image, among the plurality of objects, in the virtual space and the stored viewpoint position.

5. The game device according to claim 4,
wherein the attention area is placed in the center of the generated image.

6. The game device according to claim 4,
further comprising an input receiving unit which receives a selection instruction input to select the object from a user,
wherein the distance calculation unit sets the attention area so that the generated position of the selected object is centered in a screen.

7. The game device according to claim 6,
wherein the input receiving unit further receives a move instruction input to move the position of the selected object from the user,
wherein the storage unit further stores a history of predetermined number of times of the move instruction inputs,
wherein the update unit further updates the position of the selected object based on the move instruction input, and
wherein the distance calculation unit changes a position of the attention area so as to follow the object based on the stored history in a predetermined time period after the object has started to move, if the position of the selected object moves.

8. The game device according to claim 6,
wherein the input receiving unit further receives a move instruction input to move the position of the selected object by a specified amount,
wherein the storage unit further stores a history of a predetermined number of times of the move instruction inputs, and
wherein the correction unit obtains a correction amount of the moving distance based on each of specified amounts indicated by the stored move instruction inputs and performs the correction so that the corrected moving distance monotonically decreases relative to the obtained distance.

9. The game device according to claim 4,
wherein if a plurality objects are drawn in the attention area of the generated image, the distance calculation unit calculates an average value of distances between the relative positions of the objects in the virtual space and the stored viewpoint position, and
wherein the correction unit corrects the calculated moving distance so as to monotonically decrease relative to the calculated average value.

10. The game device according to claim 4,
wherein, if a plurality objects are drawn in the attention area of the generated image, the distance calculation unit calculates a maximum value of distances between the positions of the objects in the virtual space and the stored viewpoint position, and
wherein the correction unit corrects the calculated moving distance so as to monotonically decrease relative to the calculated maximum value.

11. The game device according to claim 4,
wherein, if a plurality of objects is drawn in the attention area of the generated image, the distance calculation unit calculates a minimum value of distances between the respective positions of the objects in the virtual space and the stored viewpoint position, and
wherein the correction unit corrects the calculated moving distance so as to monotonically decrease relative to the calculated minimum value.

12. The game device according to claim 4,
wherein, if a plurality of objects is drawn in the attention area of the generated image, the distance calculation unit calculates a total value of distances between the respective positions of the objects in the virtual space and the stored viewpoint position, and
wherein the correction unit corrects the calculated moving distance so as to monotonically decrease relative to the calculated total value.

13. A game processing method performed by a game device with a storage unit,
the storage unit storing a position of an object placed in a virtual space and a viewpoint position placed in the virtual space, the method comprising:
a generation step to generate an image representing the object viewed from the viewpoint position in the virtual space;
a display step to display the generated image;
a distance calculation step to obtain a distance between the position of the object in the virtual space and the stored viewpoint position;
a move calculation step to calculate a moving direction and a moving distance of the move of the viewpoint position;
a correction step to correct the calculated moving distance based on the obtained distance; and
an update step to perform updating so as to move the stored viewpoint position in the calculated moving direction by the corrected moving distance;
wherein, in the correction step, the correction is performed so that the corrected moving distance monotonically decreases relative to the obtained distance.

14. A game processing method performed by a game device with a storage unit,
the storage unit storing a position of an object placed in a virtual space, a viewpoint position placed in the virtual space, and a sight line direction placed in the virtual space, the method comprising:
a generation step to generate an image representing the object viewed from the viewpoint position in the sight line direction in the virtual space;
a display step to display the generated image;
a distance calculation step to obtain a distance between a position of the object in the virtual space and the stored viewpoint position;
a move calculation step to calculate a rotation direction and a rotation angle of the rotation of the sight line direction;
a correction step to correct the calculated rotation angle based on the obtained distance; and
an update step to perform updating so as to rotate the stored sight line direction in the calculated rotation direction by the corrected rotation angle;
wherein in the correction step the correction is performed so that the corrected rotation angle monotonically decreases relative to the obtained distance.

15. A computer-readable information recording medium to store a program, the program making a computer function as:
a storage unit which stores a position of an object placed in a virtual space and a viewpoint position placed in the virtual space;
a generation unit which generates an image representing the object viewed from the viewpoint position in the virtual space;
a display unit which displays the generated image;
a distance calculation unit which obtains a distance between the position of the object in the virtual space and the stored viewpoint position;
a move calculation unit which calculates a moving direction and a moving distance of the move of the viewpoint position;
a correction unit which corrects the calculated moving distance based on the obtained distance; and
an update unit which performs updating so as to move the stored viewpoint position in the calculated moving direction by the corrected moving distance;
wherein the correction unit performs the correction so that the corrected moving distance monotonically decreases relative to the obtained distance.

16. A computer-readable information recording medium to store a program, the program making a computer function as:
a storage unit which stores a position of an object placed in a virtual space, a viewpoint position placed in the virtual space, and a sight line direction placed in the virtual space;
a generation unit which generates an image representing the object viewed from the viewpoint position in the sight line direction in the virtual space;
a display unit which displays the generated image;
a distance calculation unit which obtains a distance between the position of the object in the virtual space and the stored viewpoint position;
a move calculation unit which calculates a rotation direction and a rotation angle of the rotation of the sight line direction;
a correction unit which corrects the calculated rotation angle based on the obtained distance; and
an update unit which performs updating so as to rotate the stored sight line direction in the calculated rotation direction by the corrected rotation angle;
wherein the correction unit performs the correction so that the corrected rotation angle monotonically decreases relative to the obtained distance.

17. A program making a computer function as
a storage unit which stores a position of an object placed in a virtual space and a viewpoint position placed in the virtual space;
a generation unit which generates an image representing the object viewed from the viewpoint position in the virtual space;
a display unit which displays the generated image;
a distance calculation unit which obtains a distance between the position of the object in the virtual space and the stored viewpoint position;
a move calculation unit which calculates a moving direction and a moving distance of the move of the viewpoint position;
a correction unit which corrects the calculated moving distance based on the obtained distance; and
an update unit which performs updating so as to move the stored viewpoint position in the calculated moving direction by the corrected moving distance;
wherein the correction unit performs the correction so that the corrected moving distance monotonically decreases relative to the obtained distance.

18. A program making a computer function as:
a storage unit which stores a position of an object placed in a virtual space, a viewpoint position placed in the virtual space, and a sight line direction placed in the virtual space;
a generation unit which generates an image representing the object viewed from the view point position in the sight line direction in the virtual space;
a display unit which displays the generated image;
a distance calculation unit which obtains a distance between the position of the object in the virtual space and the stored viewpoint position;
a move calculation unit which calculates a rotation direction and a rotation angle of the rotation of the sight line direction;
a correction unit which corrects the calculated rotation angle based on the obtained distance; and
an update unit which performs updating so as to rotate the stored sight line direction in the calculated rotation direction by the corrected rotation angle;
wherein the correction unit performs the correction so that the corrected rotation angle monotonically decreases relative to the obtained distance.
